(19) United States
(12) Patent Application Publication
(10) Pub. No.: US 2024/0026896 A1
(43) Pub. Date: Jan. 25, 2024

(54) CENTRIFUGAL AIR-SENDING DEVICE AND AIR-CONDITIONING APPARATUS

(71) Applicants: Mitsubishi Electric Corporation, Tokyo (JP); MITSUBISHI ELECTRIC HOME APPLIANCE CO., LTD., Saitama (JP)

(72) Inventors: Takuya TERAMOTO, Tokyo (JP); Hiroyasu HAYASHI, Tokyo (JP); Ryo HORIE, Tokyo (JP); Yoshitaka AKARI, Fukaya-shi, (JP); Takashi YAMAGUCHI, Tokyo (JP); Kazuya MICHIKAMI, Tokyo (JP); Takahiro YAMATANI, Tokyo (JP)

(21) Appl. No.: 18/044,599

(22) PCT Filed: Oct. 22, 2020
(86) PCT No.: PCT/JP2020/039692

§ 371 Date: Mar. 9, 2023

(51) Int. Cl. F04D 29/28; F04D 17/16; F04D 29/30; F04D 29/42

(52) U.S. Cl. CPC F04D 29/281; F04D 17/162; F04D 29/30; F04D 29/424

(57) ABSTRACT

A centrifugal air-sending device has blades that each have a vane length in a first region that is greater than a vane length in a second region and have a portion at which a proportion for which a turbo vane portion accounts is higher in a radial direction than a proportion for which a sirocco vane portion accounts in the first region and the second region. The blades that are located closer to an outer circumference than is an inner circumferential side end portion of a bell mouth that is located closest to an inner circumference in the radial direction is defined as a blade outer circumferential portion that is formed such that the proportion for which the sirocco vane portion accounts is higher in the radial direction than or equal to the proportion for which the turbo vane portion accounts in the first region and the second region.

### TECHNICAL FIELD

The present disclosure relates to a centrifugal air-sending device that includes an impeller and an air-conditioning apparatus that includes the centrifugal air-sending device.

### BACKGROUND ART

There has been a centrifugal air-sending device that has a scroll casing that is scroll-shaped and has a bell mouth formed at an air inlet and an impeller that is installed in the scroll casing and is configured to rotate about an axial center (refer to, for example, Patent Literature 1). The impeller disclosed in Patent Literature 1 and included in the centrifugal air-sending device has a main plate that is disk-shaped, a side plate that is ring-shaped, and blades radially arranged. The blades included in this impeller are arranged such that their inner diameter increases from the main plate toward the side plate. The blades also are sirocco vanes, which are forward-curved blades, and that each have a blade outlet angle of greater than or equal to 100 degrees and have inducer portions of turbo vanes, which are backward-curved blades, at an inner circumference of the blades.

### CITATION LIST

### Patent Literature

Patent Literature 1: Japanese Unexamined Patent Application Publication No. 2000-240590

### SUMMARY OF INVENTION

### Technical Problem

In a case in which an impeller is resin-molded, to prevent its side plate from sticking to a mold, such a side plate has been ring-shaped and provided to outer circumferential side face of the impeller. In a centrifugal air-sending device that has an impeller that has such a configuration, an airflow blown in a radial direction of the impeller may pass outward around the side plate as its center and along an inner side surface of a bell mouth and flow into the impeller again. In the centrifugal air-sending device disclosed in Patent Literature 1, portions of blades that are located further outward than an inner circumferential side end portion of the bell mouth are formed only by portions formed as sirocco vane portions. When an airflow blown out from the impeller and along an inner wall surface of the bell mouth flows into the impeller again, the airflow thus collides with the sirocco vane portions, which each have a large outlet angle and at which the airflow passes at increased inflow velocity. Noise generated from the centrifugal air-sending device may be thus caused and deterioration in input may be caused as well.

The present disclosure is to solve the above problem and to provide a centrifugal air-sending device, in which, when an airflow that passes along the inner wall surface of the bell mouth passes into the impeller again, noise generated from the airflow and deterioration in input are prevented, and an air-conditioning apparatus that includes the centrifugal air-sending device.

### Solution to Problem

A centrifugal air-sending device according to an embodiment of the present disclosure has an impeller that has a main plate that is to be driven to rotate, a side plate that is ring-shaped and located such that the side plate faces the main plate, and a plurality of blades that each have one end connected to the main plate and an other end connected to the side plate and are arranged in a circumferential direction centered on a rotation axis of the main plate that is virtual; and a scroll casing that houses the impeller and has a circumferential wall that is scroll-shaped and a side wall that has a bell mouth that forms a suction port that communicates with a space defined by the main plate and the plurality of blades, in which the plurality of blades each have an inner circumferential end that is closer to the rotation axis than is an outer circumferential end in a radial direction centered on the rotation axis, the outer circumferential end that is closer to an outer circumference than is the inner circumferential end in the radial direction, a sirocco vane portion that includes the outer circumferential end and forms a forward-curved blade at which an outlet angle is formed larger than 90 degrees, a turbo vane portion that includes the inner circumferential end and forms a backward-curved blade, a first region that is located closer to the main plate than is an intermediate position in an axial direction of the rotation axis, and a second region that is located closer to the side plate than is the first region, the plurality of blades have a blade outer diameter of the respective outer circumferential ends of the plurality of blades and the blade outer diameter is larger than an inner diameter of the bell mouth, the plurality of blades each have a vane length in the first region that is greater than a vane length in the second region, the plurality of blades each have a portion at which a proportion for which the turbo vane portion accounts is higher in the radial direction than a proportion for which the sirocco vane portion accounts in the first region and the second region, and, in a case in which portions of the plurality of blades that are located closer to the outer circumference than is an inner circumferential side end portion that is an end portion of the bell mouth that is located closest to an inner circumference in the radial direction are defined as a blade outer circumferential portion, the blade outer circumferential portion is formed such that the proportion for which the sirocco vane portion accounts is higher in the radial direction than or equal to the proportion for which the turbo vane portion accounts in the first region and the second region.

An air-conditioning apparatus according to another embodiment of the present disclosure has the centrifugal air-sending device, which has a configuration described above.

### Advantageous Effects of Invention

According to an embodiment of the present disclosure, the blade outer circumferential portion is formed such that the proportion for which the sirocco vane portion accounts is higher in the radial direction than or equal to the proportion for which the turbo vane portion accounts in the first region and the second region. The centrifugal air-sending device that has the configuration described above is configured to further increase an air volume and a pressure of an airflow blown out from the impeller in comparison with a centrifugal air-sending device that does not have the configuration described above. In the centrifugal air-sending device that has the configuration described above, an airflow that passes along an inner wall surface of the bell mouth into the impeller again thus collides with the turbo vane portions, which each have a small outlet angle and at which the airflow passes at decreased inflow velocity. As a result, in the centrifugal air-sending device, when the airflow that passes along the inner wall surface of the bell mouth passes into the impeller again, noise generated from the airflow is thus prevented and deterioration in input is prevented as well.

### BRIEF DESCRIPTION OF DRAWINGS

FIG. 1 is a perspective view that schematically illustrates a centrifugal air-sending device according to Embodiment 1.

FIG. 2 is an external view that schematically illustrates a configuration of the centrifugal air-sending device according to Embodiment 1 with the configuration viewed parallel to a rotation axis RS.

FIG. 3 is a sectional view that schematically illustrates a section of the centrifugal air-sending device illustrated in FIG. 2 taken along line A-A.

FIG. 4 is a perspective view that illustrates an impeller included in the centrifugal air-sending device according to Embodiment 1.

FIG. 5 is a perspective view that illustrates the impeller illustrated in FIG. 4 with the impeller viewed opposite to the perspective view illustrated in FIG. 4.

FIG. 6 is a plan view that illustrates the impeller included in the centrifugal air-sending device according to Embodiment 1 with the impeller viewed toward one face of the main plate.

FIG. 7 is a plan view that illustrates the impeller included in the centrifugal air-sending device according to Embodiment 1 with the impeller viewed toward the other face of the main plate.

FIG. 8 is a sectional view that illustrates the impeller illustrated in FIG. 6 taken along line B-B.

FIG. 9 is a side view that illustrates the impeller illustrated in FIG. 4.

FIG. 10 is a schematic view that illustrates a section of blades included in the impeller illustrated in FIG. 9 taken along line C-C.

FIG. 11 is a schematic view that illustrates a section of the blades included in the impeller illustrated in FIG. 9 taken along line D-D.

FIG. 12 is a schematic view that illustrates a relationship between the impeller and a scroll casing included in the centrifugal air-sending device illustrated in FIG. 2 with the centrifugal air-sending device viewed in a section taken along line A-A.

FIG. 13 is a schematic view that illustrates a relationship between the blades and a bell mouth with the impeller illustrated in FIG. 12 viewed parallel to the rotation axis RS.

FIG. 14 is a schematic view that illustrates a relationship between the impeller and the scroll casing included in the centrifugal air-sending device illustrated in FIG. 2 with the centrifugal air-sending device viewed in the section taken along line A-A.

FIG. 15 is a schematic view that illustrates a relationship between the blades and the bell mouth with the impeller illustrated in FIG. 14 viewed parallel to the rotation axis RS.

FIG. 16 is a schematic view that illustrates a relationship between the impeller and the bell mouth included in the centrifugal air-sending device illustrated in FIG. 2 with the centrifugal air-sending device viewed in the section taken along line A-A.

FIG. 17 is a schematic view that illustrates a relationship between the blades and the bell mouth with the impeller illustrated in FIG. 16 viewed in a second section and viewed parallel to the rotation axis RS.

FIG. 18 is a conceptual view that illustrates a relationship between the impeller and the bell mouth illustrated in FIG. 16 and FIG. 17.

FIG. 19 is a sectional view that illustrates a centrifugal air-sending device according to a comparative example.

FIG. 20 is a sectional view that schematically illustrates a centrifugal air-sending device according to Embodiment 2.

FIG. 21 is a sectional view that schematically illustrates a centrifugal air-sending device according to Embodiment 3.

FIG. 22 is an enlarged view that illustrates a portion of the impeller included in the centrifugal air-sending device according to Embodiment 3 that is in range E in the impeller illustrated in FIG. 6.

FIG. 23 is a sectional view that schematically illustrates a centrifugal air-sending device according to Embodiment 4.

FIG. 24 is an enlarged view that illustrates a portion of the impeller included in the centrifugal air-sending device according to Embodiment 4 that is in range E in the impeller illustrated in FIG. 6.

FIG. 25 is a conceptual view that illustrates a relationship between impellers and a motor included in a centrifugal air-sending device according to Embodiment 5.

FIG. 26 is a conceptual view that illustrates a centrifugal air-sending device that is a modification 1 of the centrifugal air-sending device according to Embodiment 5.

FIG. 27 is a conceptual view that illustrates a centrifugal air-sending device that is a modification 2 of the centrifugal air-sending device according to Embodiment 5.

FIG. 28 is a sectional view that schematically illustrates a centrifugal air-sending device according to Embodiment 6.

FIG. 29 is a sectional view that schematically illustrates a centrifugal air-sending device according to a comparative example.

FIG. 30 is a sectional view that schematically illustrates an operation of the centrifugal air-sending device according to Embodiment 6.

FIG. 31 is a sectional view that illustrates a centrifugal air-sending device that is a first modification of the centrifugal air-sending device according to Embodiment 6.

FIG. 32 is a sectional view that illustrates a centrifugal air-sending device that is a second modification of the centrifugal air-sending device according to Embodiment 6.

FIG. 33 is a schematic view that illustrates a relationship between the bell mouth and a blade included in a centrifugal air-sending device according to Embodiment 7.

FIG. 34 is a schematic view that illustrates a relationship between a bell mouth and a blade included in a centrifugal air-sending device that is a modification of the centrifugal air-sending device according to Embodiment 7.

FIG. 35 is a sectional view that schematically illustrates a centrifugal air-sending device according to Embodiment 8.

FIG. 36 is a schematic view that illustrates blades included in the impeller illustrated in FIG. 35 with the blades viewed parallel to the rotation axis RS.

FIG. 37 is a schematic view that illustrates the blades included in the impeller illustrated in FIG. 35 with the blades viewed in a section taken along line D-D.

FIG. 38 is a perspective view of an air-conditioning apparatus according to Embodiment 9.

FIG. 39 is a perspective view of an internal configuration of the air-conditioning apparatus according to Embodiment 9.

### DESCRIPTION OF EMBODIMENT

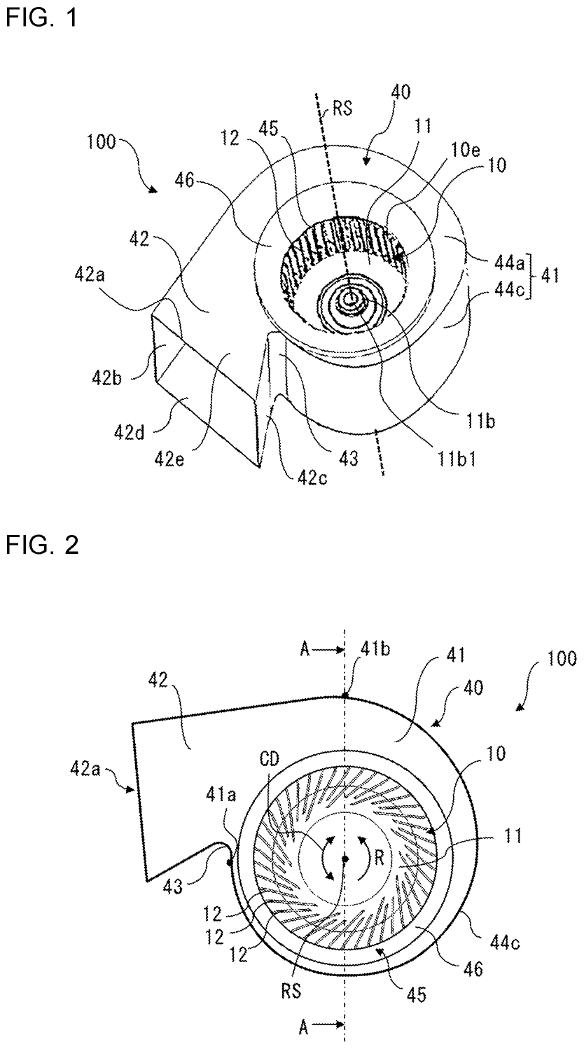

A centrifugal air-sending device and an air-conditioning apparatus according to embodiments are described below with reference to the drawings and other reference. In the drawings below, which include FIG. 1, the relative dimensions, shapes, and other details of various components may differ from those of the actual components. In addition, components given the same reference signs in the following drawings are the same as or equivalent to each other, and these reference signs are common through the full text of the specification. In addition, the directional terms, such as “upper”, “lower”, “right”, “left”, “front”, and “back”, used as appropriate for ease of comprehension are merely so written for convenience of explanation, and the placement or orientation of a device or a component is not limited by the directional terms.

### Embodiment 1

[Centrifugal Air-Sending Device 100]

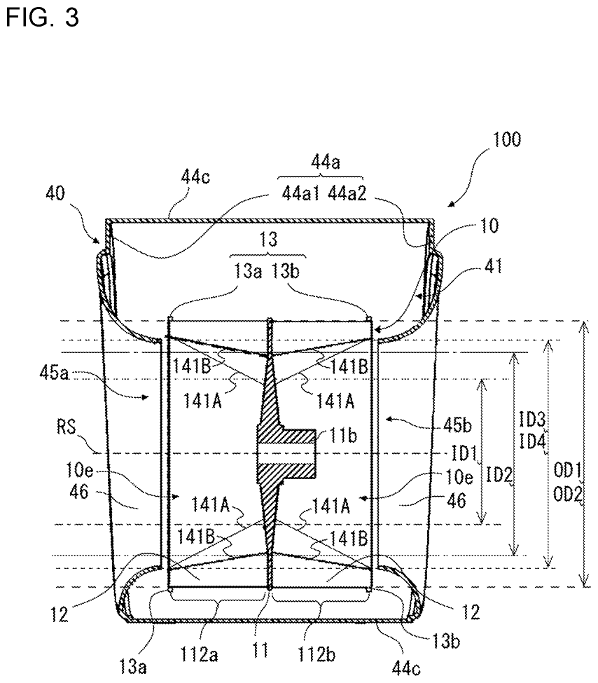

FIG. 1 is a perspective view that schematically illustrates a centrifugal air-sending device 100 according to Embodiment 1. FIG. 2 is an external view that schematically illustrates a configuration of the centrifugal air-sending device 100 according to Embodiment 1 with the configuration viewed parallel to a rotation axis RS. FIG. 3 is a sectional view that schematically illustrates a section of the centrifugal air-sending device 100 illustrated in FIG. 2 taken along line A-A. A basic structure of the centrifugal air-sending device 100 is described below with reference to FIG. 1 to FIG. 3.

The centrifugal air-sending device 100 is a multi-blade air-sending device and has an impeller 10 configured to generate an airflow and a scroll casing 40, which houses the impeller 10. The centrifugal air-sending device 100 is also a double-suction centrifugal air-sending device through which air is sucked from both sides of the scroll casing 40 in an axial direction of the rotation axis RS, which is virtual, of the impeller 10.

[Scroll Casing 40]

The scroll casing 40 houses the impeller 10 for the centrifugal air-sending device 100 and rectifies air blown out from the impeller 10. The scroll casing 40 has a scroll portion 41 and a discharge portion 42.

Scroll Portion 41

The scroll portion 41 forms an air passage through which a dynamic pressure of an airflow generated by the impeller 10 is converted into a static pressure. The scroll portion 41 has side walls 44a that each cover the impeller 10 in the axial direction of the rotation axis RS of the boss portion 11b included in the impeller 10 and each have a casing suction port 45 formed in the side wall 44a and through which air is sucked and a circumferential wall 44c that surrounds the impeller 10 in radial directions from the rotation axis RS of the boss portion 11b.

In addition, the scroll portion 41 has a tongue portion 43, located between a discharge portion 42 and a scroll start portion 41a of the circumferential wall 44c, that has a curved surface and guides an airflow generated by the impeller 10 toward a discharge port 42a through the scroll portion 41. The radial directions from the rotation axis RS are each a direction perpendicular to the rotation axis RS. The scroll portion 41 has an internal space, defined by the circumferential wall 44c and the side walls 44a, in which air blown out from the impeller 10 flows along the circumferential wall 44c.

Side Walls 44a

The side walls 44a are located at both respective faces of the impeller 10 in the axial direction of the rotation axis RS of the impeller 10. The side walls 44a of the scroll casing 40 each have the casing suction port 45 formed in the side wall 44a such that air is allowed to flow between the impeller 10 and an outside of the scroll casing 40.

The casing suction port 45 is formed in a circular shape and the impeller 10 is located such that the center of the casing suction port 45 and the center of the boss portion 11b of the impeller 10 substantially coincide with each other. The shape of the casing suction port 45 is not limited to the circular shape and may also be another shape, such as an elliptical shape.

The scroll casing 40 of the centrifugal air-sending device 100 is a double-suction casing that has the side walls 44a, which have the respective casing suction ports 45 at both faces of the main plate 11 in the axial direction of the rotation axis RS of the boss portion 11b.

The centrifugal air-sending device 100 has the two side walls 44a in the scroll casing 40. The two side walls 44a are formed such that the side walls 44a face each other across the circumferential wall 44c. More specifically, as illustrated in FIG. 3, the scroll casing 40 has a first side wall 44a1 and a second side wall 44a2 as the side walls 44a.

The first side wall 44a1 has a first suction port 45a formed in the first side wall 44a1. The first suction port 45a faces a plate surface of the main plate 11 on which a first side plate 13a, which is described later, is located. The second side wall 44a2 has a second suction port 45b formed in the second side wall 44a2. The second suction port 45b faces a plate surface of the main plate 11 on which a second side plate 13b, which is described later, is located. The first suction port 45a and the second suction port 45b are collectively referred to as the casing suction ports 45 described above.

The casing suction port 45 located in the side wall 44a is formed by a bell mouth 46. In other words, the bell mouth 46 forms the casing suction port 45, which communicates with a space defined by the main plate 11 and a plurality of blades 12. The bell mouth 46 rectifies a flow of gas to be sucked into the impeller 10 and causes the gas to flow into the air inlet 10e of the impeller 10.

The bell mouth 46 has an opening of which a diameter gradually decreases from the outside toward the inside of the scroll casing 40. Such a configuration of each of the side walls 44a allows air around the casing suction ports 45 to smoothly flow along the bell mouths 46 and efficiently flow from the casing suction ports 45 into the impeller 10.

Circumferential Wall 44c

The circumferential wall 44c is a wall that has a curved wall surface along which an airflow generated by the impeller 10 is guided toward the discharge port 42a. The circumferential wall 44c is located between the side walls 44a, which face each other, and forms a curved surface that extends along the rotation direction R of the impeller 10. The circumferential wall 44c is located, for example, parallel to the axial direction of the rotation axis RS of the impeller 10 and covers the impeller 10. The circumferential wall 44c may also be shaped such that the circumferential wall 44c is inclined to the axial direction of the rotation axis RS in the impeller 10 and is not limited to be located parallel to the axial direction of the rotation axis RS.

The circumferential wall 44c has an inner circumferential surface that covers the impeller 10 in the radial directions of the boss portion 11b and faces the plurality of blades 12, which are described later. The circumferential wall 44c faces air outlets of the blades 12 in the impeller 10. As illustrated in FIG. 2, the circumferential wall 44c is located over an area from the scroll start portion 41a located at a boundary between the circumferential wall 44c and the tongue portion 43 to a scroll end portion 41b located at a boundary between the scroll portion 41 and an end of the discharge portion 42 that is located farthest from the tongue portion 43 along the rotation direction R of the impeller 10.

The scroll start portion 41a is an upstream end portion of the circumferential wall 44c, which forms a curved surface, in a direction in which gas is caused by rotation of the impeller 10 to flow along the circumferential wall 44c in an internal space in the scroll casing 40. The scroll end portion 41b is a downstream end portion of the circumferential wall 44c, which forms the curved surface, in the direction in which gas is caused by rotation of the impeller 10 to flow along the circumferential wall 44c in the internal space in the scroll casing 40.

The circumferential wall 44c is formed in a spiral shape. The spiral shape is, for example, a shape formed by a logarithmic spiral, an Archimedean spiral, or an involute curve. The inner circumferential surface of the circumferential wall 44c has the curved surface, which is smoothly curved along a circumferential direction of the impeller 10 from the scroll start portion 41a, which is a starting end of the spiral shape, to the scroll end portion 41b, which is a terminating end of the spiral shape. Such a configuration allows air sent out from the impeller 10 to smoothly flow through a gap between the impeller 10 and the circumferential wall 44c in a direction toward the discharge portion 42. A static pressure of air from the tongue portion 43 toward the discharge portion 42 in the scroll casing 40 thus efficiently increases.

Discharge Portion 42

The discharge portion 42 forms the discharge port 42a through which an airflow that is generated by the impeller 10 and has passed through the scroll portion 41 is discharged. The discharge portion 42 is formed by a hollow pipe that has a rectangular section orthogonal to a direction in which air flows along the circumferential wall 44c. Such a sectional shape of the discharge portion 42 is not limited to a rectangular shape. The discharge portion 42 forms a flow passage through which air that is sent out from the impeller 10 and flows through the gap between the circumferential wall 44c and the impeller 10 is guided to be discharged out from the scroll casing 40.

As illustrated in FIG. 1, the discharge portion 42 is formed by an extension plate 42b, a diffuser plate 42c, a first side plate portion 42d, a second side plate portion 42e, and other components. The extension plate 42b is formed integrally with the circumferential wall 44c such that the extension plate 42b smoothly continues to the scroll end portion 41b, which is located downstream of the circumferential wall 44c. The diffuser plate 42c is formed integrally with the tongue portion 43 of the scroll casing 40 and faces the extension plate 42b. The diffuser plate 42c is formed at a predetermined angle to the extension plate 42b such that a sectional area of the flow passage gradually increases along a direction in which air flows in the discharge portion 42.

The first side plate portion 42d is formed integrally with the first side wall 44a1 of the scroll casing 40, and the second side plate portion 42e is formed integrally with the second side wall 44a2 of the scroll casing 40, which is located opposite to the first side wall 44a1. The first side plate portion 42d and the second side plate portion 42e are formed between the extension plate 42b and the diffuser plate 42c. The discharge portion 42 thus has a rectangular-sectional flow passage defined by the extension plate 42b, the diffuser plate 42c, the first side plate portion 42d, and the second side plate portion 42e.

Tongue Portion 43

In the scroll casing 40, the tongue portion 43 is formed between the diffuser plate 42c of the discharge portion 42 and the scroll start portion 41a of the circumferential wall 44c. The tongue portion 43 is formed with a predetermined radius of curvature such that the circumferential wall 44c is smoothly connected to the diffuser plate 42c through the tongue portion 43.

The tongue portion 43 reduces inflow of air from a scroll ending portion to a scroll starting portion of the flow passage, which is spiral-shaped. The tongue portion 43 is located upstream in an air duct and separates an airflow along the rotation direction R of the impeller 10 and an airflow from a downstream portion in the air duct toward the discharge port 42a. In addition, while an airflow is passing through the scroll casing 40, the airflow, which then passes into the discharge portion 42, rises in static pressure to be higher in pressure than the airflow in the scroll casing 40. For this reason, the tongue portion 43 is formed to separate such different pressures.

[Impeller 10]

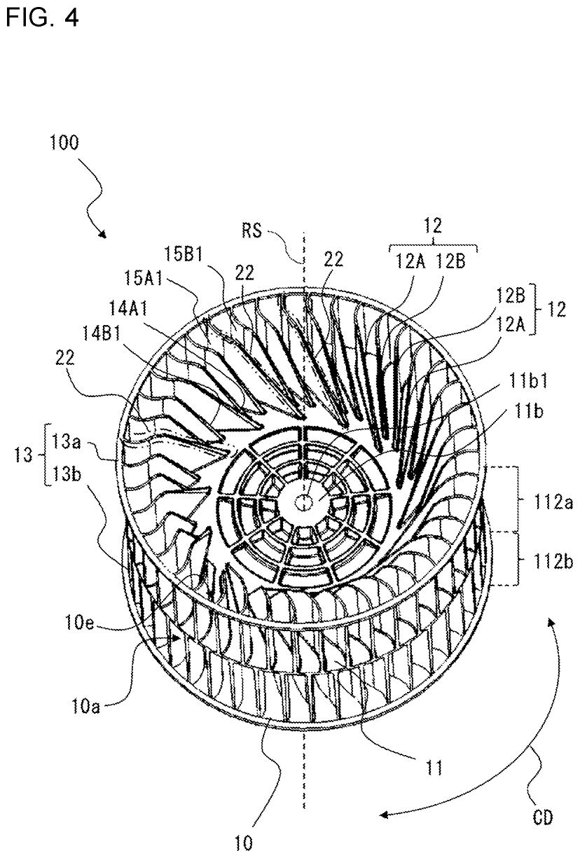

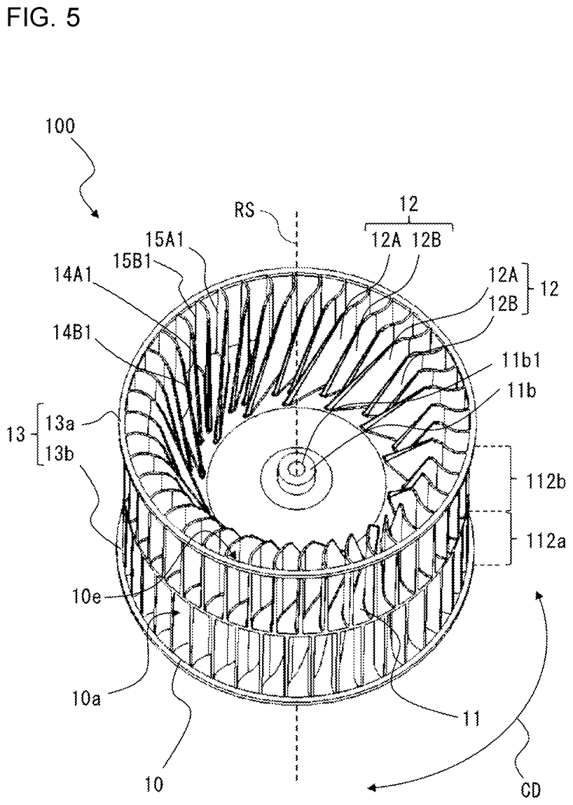

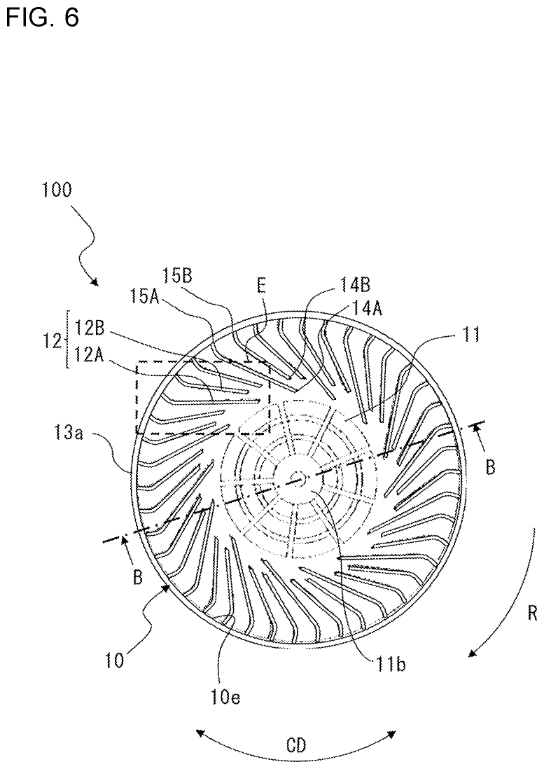

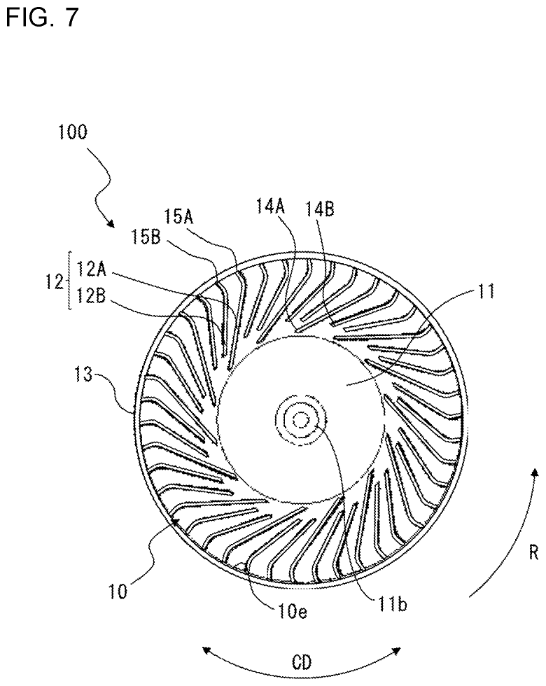

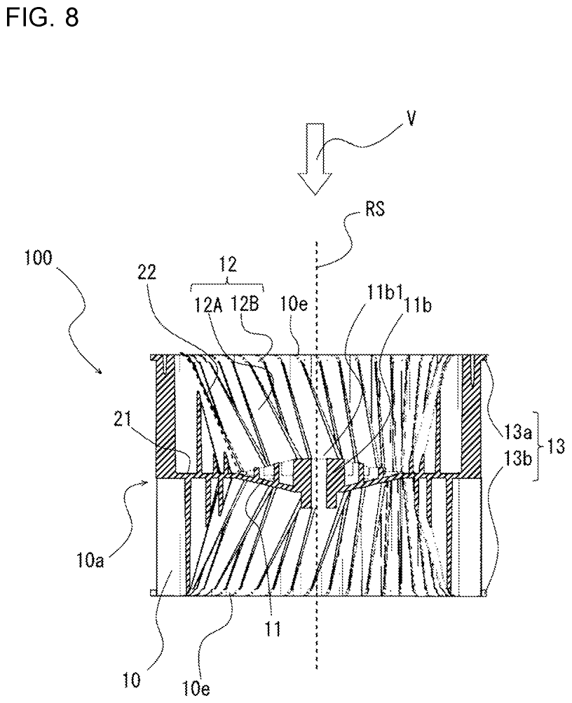

FIG. 4 is a perspective view that illustrates the impeller 10 included in the centrifugal air-sending device 100 according to Embodiment 1. FIG. 5 is a perspective view that illustrates the impeller 10 illustrated in FIG. 4 with the impeller 10 viewed opposite to the perspective view illustrated in FIG. 4. FIG. 6 is a plan view that illustrates the impeller 10 included in the centrifugal air-sending device 100 according to Embodiment 1 with the impeller 10 viewed toward one face of the main plate 11. FIG. 7 is a plan view that illustrates the impeller 10 included in the centrifugal air-sending device 100 according to Embodiment 1 with the impeller 10 viewed toward the other face of the main plate 11. FIG. 8 is a sectional view that illustrates the impeller 10 illustrated in FIG. 6 taken along line B-B. The impeller 10 is described below with reference to FIG. 4 to FIG. 8.

The impeller 10 is a centrifugal fan. The impeller 10 is connected to an unillustrated motor that has a drive shaft. The impeller 10 is driven by the motor into rotation. The rotation generates a centrifugal force with which the impeller 10 forcibly sends out air outward in the radial directions. The impeller 10 is driven by the motor or other drive source to rotate in the rotation direction R, which is illustrated by an arrow. As illustrated in FIG. 4, the impeller 10 has the main plate 11, which is disk-shaped, side plates 13, which are each ring-shaped, and the plurality of blades 12 arranged on a circumferential edge portion of the main plate 11 and arranged radially around the rotation axis RS as their center.

Main Plate 11

The main plate 11 is only required to be plate-shaped and may also be formed in a polygonal shape or other shape other than such a disk shape. The main plate 11 may also be formed such that the thickness of the main plate 11 increases toward the center of the main plate 11 in the radial direction centered on the rotation axis RS as illustrated in FIG. 3. Alternatively, the main plate 11 may also be formed such that the thickness of the main plate 11 is constant in the radial direction centered on the rotation axis RS. In addition, the main plate 11 is not limited to one plate component. The main plate 11 may also be a plurality of plate components that are integrally fixed to each other.

The boss portion 11b, to which the drive shaft of the motor is connected, is located at the center portion of the main plate 11. In the boss portion 11b, a shaft hole 11b1 is opened. To the shaft hole 11b1, the drive shaft of the motor is inserted. The boss portion 11b is described to be circular-cylindrical-shaped. The boss portion 11b is, however, not limited to such a circular cylindrical shape. The boss portion 11b is only required to be pillar-shaped. The boss portion 11b may also be, for example, polygonal-pillar-shaped. The main plate 11 is driven to rotate by the motor by use of the boss portion 11b.

Side Plates 13

The impeller 10 has side plates 13, which are each ring-shaped, are each attached to the corresponding end portions of the plurality of blades 12 that are opposite to the main plate 11 in the axial direction of the rotation axis RS of the boss portion 11b. The side plates 13 are located at an outer circumferential side face 10a of the impeller 10. In the impeller 10, the side plates 13 each face the main plate 11. The side plates 13 are located outside the blades 12 in the radial directions centered on the rotation axis RS. The side plates 13 define the respective air inlets 10e of the impeller 10. The side plates 13 each connect the plurality of blades 12 with each other and thus maintain a positional relationship between tips of the blades 12 and reinforce the plurality of blades 12.

The side plates 13 includes the first side plate 13a, which is ring-shaped and faces the main plate 11, and the second side plate 13b, which is ring-shaped and faces the main plate 11 at a position opposite to a position at which the first side plate 13a is located. The first side plate 13a and the second side plate 13b are collectively referred to as the side plates 13. The impeller 10 has the first side plate 13a, which is spaced from one face of the main plate 11, and the second side plate 13b, which is spaced from the other face of the main plate 11, in the axial direction of the rotation axis RS.

Blades 12

As illustrated in FIG. 4, the plurality of blades 12 each have one edge connected to the main plate 11 and the other edge connected to the corresponding one of the side plates 13. The plurality of blades 12 are arranged in a circumferential direction CD centered on the rotation axis RS, which is virtual, of the main plate 11. The plurality of blades 12 are each located between the main plate 11 and the corresponding one of the side plates 13. The plurality of blades 12 are located at both respective faces of the main plate 11 in the axial direction of the rotation axis RS of the boss portion 11b. Each of the blades 12 is regularly spaced from another one of the blades 12 on the circumferential edge portion of the main plate 11.

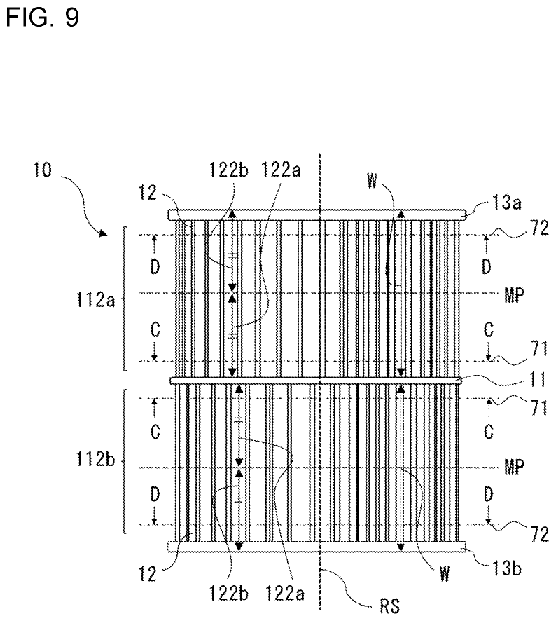

FIG. 9 is a side view that illustrates the impeller 10 illustrated in FIG. 4. As illustrated in FIG. 4 and FIG. 9, the impeller 10 has a first vane portion 112a and a second vane portion 112b. The first vane portion 112a and the second vane portion 112b are each formed by the corresponding ones of the plurality of blades 12 and the corresponding one of the side plates 13. More specifically, the first vane portion 112a is formed by the first side plate 13a, which is ring-shaped, and ones of the plurality of blades 12 that are located between the main plate 11 and the first side plate 13a. The second vane portion 112b is formed by the second side plate 13b, which is ring-shaped, and ones of the plurality of blades 12 that are located between the main plate 11 and the second side plate 13b.

The first vane portion 112a is located at one plate surface of the main plate 11 and the second vane portion 112b is located at the other plate surface of the main plate 11. In other words, sets of the plurality of blades 12 are located at both respective faces of the main plate 11 in the axial direction of the rotation axis RS. The first vane portion 112a and the second vane portion 112b are located opposite to each other across the main plate 11. In FIG. 3, the first vane portion 112a is located at the left face of the main plate 11 and the second vane portion 112b is located at the right face of the main plate 11. The first vane portion 112a and the second vane portion 112b are, however, only required to be located opposite to each other across the main plate 11. The first vane portion 112a may also be located at the right face of the main plate 11 and the second vane portion 112b may also be located at the left face of the main plate 11. In description below, unless otherwise noted, the blades 12 included in the first vane portion 112a and the blades 12 included in the second vane portion 112b are collectively referred to as the blades 12.

As illustrated in FIG. 4 and FIG. 5, the impeller 10 is formed in a tube shape by the plurality of blades 12 located at the main plate 11. Furthermore, the impeller 10 has the air inlets 10e, through which gas flows into a space defined by the main plate 11 and the plurality of blades 12. The air inlets 10e are located at the respective side plates 13, which are opposite to the main plate 11 in the axial direction of the rotation axis RS of the boss portion 11b. The impeller 10 has the blades 12 and the side plates 13 at both respective faces of the plate surfaces of the main plate 11. The air inlets 10e of the impeller 10 are formed at both respective faces of the plate surfaces of the main plate 11.

When the unillustrated motor drives the impeller 10, the impeller 10 rotates about the rotation axis RS as its center. When the impeller 10 rotates, gas outside the centrifugal air-sending device 100 passes through the casing suction ports 45 formed in the scroll casing 40 and the air inlets 10e of the impeller 10, which are illustrated in FIG. 1, and is sucked into the space defined by the main plate 11 and the plurality of blades 12. When the impeller 10 rotates, air sucked into the space defined by the main plate 11 and the plurality of blades 12 then passes through a space between ones of the blades 12 that are next to each other and is sent outward in the radial directions of the impeller 10.

Details of Configuration of Blades 12

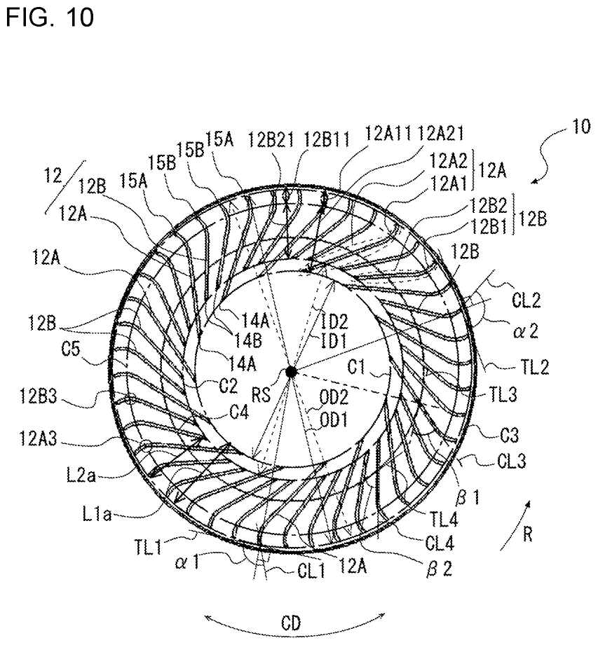

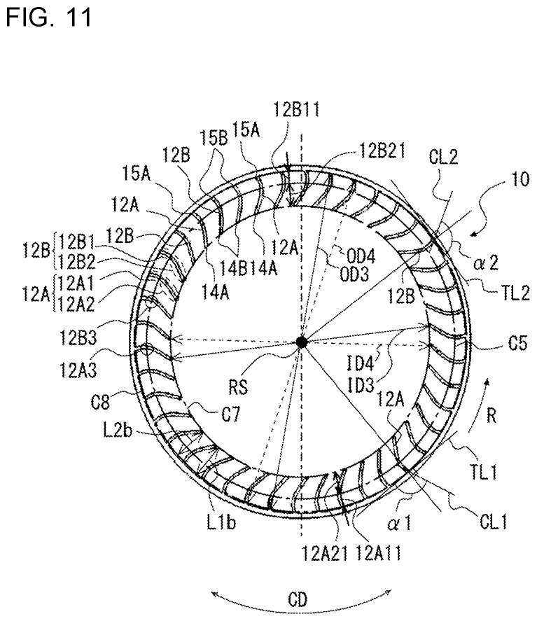

FIG. 10 is a schematic view that illustrates the blades 12 included in the impeller 10 illustrated in FIG. 9 with the blades 12 viewed in a section taken along line C-C. FIG. 11 is a schematic view that illustrates the blades 12 included in the impeller 10 illustrated in FIG. 9 with the blades 12 viewed in a section taken along line D-D. An intermediate position MP in the impeller 10 illustrated in FIG. 9 is an intermediate position of the plurality of blades 12 included in the first vane portion 112a in the axial direction of the rotation axis RS. Another intermediate position MP in the impeller 10 illustrated in FIG. 9 is an intermediate position of the plurality of blades 12 included in the second vane portion 112b in the axial direction of the rotation axis RS.

In the plurality of blades 12 included in the first vane portion 112a, a range from the intermediate position MP to the main plate 11 in the axial direction of the rotation axis RS is defined as a main-plate-side blade region 122a, which is a first region in the impeller 10. In the plurality of blades 12 included in the first vane portion 112a, a range from the intermediate position MP to the corresponding one of the side plates 13 in the axial direction of the rotation axis RS is defined as a side-plate-side blade region 122b, which is a second region in the impeller 10. In other words, in the axial direction of the rotation axis RS, the plurality of blades 12 have the first region, which is located closer to the main plate 11 than is the intermediate position MP, and the second region, which is located closer to the corresponding one of the side plates 13 than is the first region.

The section taken along line C-C illustrated in FIG. 9 is, as illustrated in FIG. 10, a section of the plurality of blades 12 that are located close to the main plate 11 of the impeller 10, that is, at the main-plate-side blade region 122a, which is the first region. The section of the blades 12 close to the main plate 11 is a first flat surface 71, which is perpendicular to the rotation axis RS, and is a first section of the impeller 10, which is obtained by cutting a portion of the impeller 10 close to the main plate 11. The portion of the impeller 10 close to the main plate 11 is a portion in the main-plate-side blade region 122a that is closer to the main plate 11 than is the intermediate position of the main-plate-side blade region 122a in the axial direction of the rotation axis RS or is a portion at which end portions of the blades 12 closest to the main plate 11 in the axial direction of the rotation axis RS is located.

The section taken along line D-D illustrated in FIG. 9 is, as illustrated in FIG. 11, a section of the plurality of blades 12 that are located close to the corresponding one of the side plates 13 of the impeller 10, that is, at a side-plate-side blade region 122b, which is the second region. The section of the blades 12 close to the corresponding one of the side plates 13 is a second flat surface 72, which is perpendicular to the rotation axis RS, and is a second face of the impeller 10, which is obtained by cutting a portion of the impeller 10 close to the corresponding one of the side plates 13. The portion of the impeller 10 close to the corresponding one of the side plates 13 is a portion in the side-plate-side blade region 122b that is closer to the corresponding one of the side plates 13 than is the intermediate position of the side-plate-side blade region 122b in the axial direction of the rotation axis RS or is a portion at which end portions of the blades 12 closest to the corresponding one of the side plates 13 in the axial direction of the rotation axis RS is located.

The basic configuration of the blades 12 included in the second vane portion 112b is similar to the basic configuration of the blades 12 included in the first vane portion 112a. In other words, in the plurality of blades 12 included in the second vane portion 112b, a range from the intermediate position MP to the main plate 11 in the axial direction of the rotation axis RS is defined as the main-plate-side blade region 122a, which is the first region in the impeller 10. In the plurality of blades 12 included in the second vane portion 112b, a range from the intermediate position MP to the second side plate 13b in the axial direction of the rotation axis RS is also defined as the side-plate-side blade region 122b, which is a second region in the impeller 10.

The basic configuration of the first vane portion 112a and the basic configuration of the second vane portion 112b are described above to be similar to each other. The configuration of the impeller 10 is, however, not limited to the configuration described above and the first vane portion 112a and the second vane portion 112b may also have different configurations. The configuration of the blades 12 described below may also include both or either one of the first vane portion 112a and the second vane portion 112b.

As illustrated in FIG. 9 to FIG. 11, the plurality of blades 12 include a plurality of first blades 12A and a plurality of second blades 12B. In the plurality of blades 12, the first blades 12A and the second blades 12B are alternately arranged in the circumferential direction CD of the impeller 10 such that one or a plurality of second blades 12B are located between the first blades 12A.

As illustrated in FIG. 9 to FIG. 11, in the impeller 10, two of the second blades 12B are located between one of the first blades 12A and another one of the first blades 12A that is located next to the one of the first blades 12A in the rotation direction R. The number of the second blades 12B located between one of the first blades 12A and another one of the first blades 12A that is located next to the one of the first blades 12A in the rotation direction R is not limited to two and may also be one or three or more. In other words, at least one second blade 12B of the plurality of second blades 12B is located between two of the plurality of first blades 12A that are next to each other in the circumferential direction CD.

As illustrated in FIG. 10, in the first section of the impeller 10, which is obtained by cutting portions with the first flat surface 71, which is perpendicular to the rotation axis RS, the first blades 12A each have an inner circumferential end 14A and an outer circumferential end 15A. The inner circumferential ends 14A are located closest to the rotation axis RS in the radial directions centered on the rotation axis RS. The outer circumferential ends 15A are located closer to an outer circumference than are the inner circumferential ends 14A in the radial directions. In each of the first blades 12A, the inner circumferential end 14A is further forward than is the outer circumferential end 15A in the rotation direction R of the impeller 10.

As illustrated in FIG. 4, the inner circumferential ends 14A are each a leading edge 14A1 of the first blade 12A and the outer circumferential ends 15A are each a trailing edge 15A1 of the first blade 12A. As illustrated in FIG. 11, the impeller 10 has the 14 first blades 12A. The number of the first blades 12A is, however, not limited to 14 and may also be less than 14 or more than 14.

As illustrated in FIG. 10, in the first section of the impeller 10, which is obtained by cutting portions with the first flat surface 71, which is perpendicular to the rotation axis RS, the second blades 12B each have an inner circumferential end 14B and an outer circumferential end 15B. The inner circumferential ends 14B are located closest to the rotation axis RS in the radial directions centered on the rotation axis RS. The outer circumferential ends 15B are located closer to the outer circumference than are the inner circumferential ends 14B in the radial directions. In each of the second blades 12B, the inner circumferential end 14B is further forward than is the outer circumferential end 15B in the rotation direction R of the impeller 10.

As illustrated in FIG. 4, the inner circumferential ends 14B are each a leading edge 14B1 of the second blade 12B and the outer circumferential ends 15B are each a trailing edge 15B1 of the second blade 12B. As illustrated in FIG. 10, the impeller 10 has the 28 second blades 12B. The number of the second blades 12B is, however, not limited to 28 and may also be less than 28 or more than 28.

Next, the relationship of each of the first blades 12A and the corresponding one of the second blades 12B is described below. As illustrated in FIG. 4 and FIG. 11, a vane length of the first blade 12A is designed to be more closely equal to a vane length of the second blade 12B as the first blade 12A is closer to the corresponding one of the first side plate 13a and the second side plate 13b than the intermediate position MP in a direction along the rotation axis RS.

On the other hand, as illustrated in FIG. 4 and FIG. 10, the vane length of the first blade 12A is designed to be greater than the vane length of the second blade 12B at a location at which the first blade 12A is closer to the main plate 11 than the intermediate position MP in the direction along the rotation axis RS. In addition, the vane length of the first blade 12A is designed to be increased as the first blade 12A is closer to the main plate 11 in the direction along the rotation axis RS. As described above, in Embodiment 1, the vane length of the first blade 12A is designed to be greater than the vane length of the second blade 12B at a least some location in the rotation axis RS. The vane length described here refers to the length of the first blade 12A in a radial direction of the impeller 10 or the length of the second blade 12B in a radial direction of the impeller 10.

In the first section, which is illustrated in FIG. 9 and is closer to the main plate 11 than the intermediate position MP, as illustrated in FIG. 10, the diameter of a circle C1, which passes the inner circumferential ends 14A of the plurality of first blades 12A around the rotation axis RS as its center, that is, the inner diameter of the first blades 12A is referred to as an inner diameter ID1. The diameter of a circle C3, which passes the outer circumferential ends 15A of the plurality of first blades 12A around the rotation axis RS as its center, that is, the outer diameter of the first blades 12A is referred to as an outer diameter OD1. Half of a difference between the outer diameter OD1 and the inner diameter ID1 is defined as a vane length L1a of the first blade 12A in the first section (vane length L1a=(outer diameter OD1−inner diameter ID1)/2).

Here, the ratio of the inner diameter of the first blade 12A to the outer diameter of the first blade 12A is lower than or equal to 0.7. In other words, the plurality of first blades 12A have a ratio of lower than or equal to 0.7 of the inner diameter ID1 of the respective inner circumferential ends 14A of the plurality of first blades 12A to the outer diameter OD1 of the respective outer circumferential ends 15A of the plurality of first blade 12A.

In a typical centrifugal air-sending device, a vane length of a blade in a section perpendicular to a rotation axis is shorter than a width dimension of the blade in a direction of the rotation axis. In Embodiment 1, the maximum possible vane length of the first blade 12A, that is, the vane length of the first blade 12A close to the main plate 11 is designed to be shorter than a width dimension W (refer to FIG. 9) in a direction of the rotation axis of the first blade 12A.

In the first section, the diameter of a circle C2, which passes the inner circumferential ends 14B of the plurality of second blades 12B around the rotation axis RS as its center, that is, the inner diameter of the second blades 12B, is referred to as an inner diameter ID2, which is larger than the inner diameter ID1 (inner diameter ID2>inner diameter ID1). The diameter of a circle C3, which passes the outer circumferential ends 15B of the plurality of second blades 12B around the rotation axis RS as its center, that is, the outer diameter of the second blades 12B is referred to as an outer diameter OD2, which is equal to the outer diameter OD1 (outer diameter OD2=outer diameter OD1). Half of a difference between the outer diameter OD2 and the inner diameter ID2 is defined as a vane length L2a of the second blade 12B in the first section (vane length L2a=(outer diameter OD2−inner diameter ID2)/2). The vane length L2a of the second blade 12B in the first section is shorter than the vane length L1a of the first blade 12A in the first section (vane length L2a<vane length L1a).

Here, the ratio of the inner diameter of the second blade 12B to the outer diameter of the second blade 12B is lower than or equal to 0.7. In other words, the plurality of second blades 12B have a ratio of lower than or equal to 0.7 of the inner diameter ID2 of the respective inner circumferential ends 14B of the plurality of second blades 12B to the outer diameter OD2 of the respective outer circumferential ends 15B of the plurality of second blades 12B.

On the other hand, in the second section, which is illustrated in FIG. 9 and is closer to the corresponding one of the side plates 13 than the intermediate position MP, as illustrated in FIG. 11, the diameter of a circle C7, which passes the inner circumferential ends 14A of the plurality of first blades 12A around the rotation axis RS as its center is referred to as an inner diameter ID3. The inner diameter ID3 is larger than the inner diameter ID1 in the first section (inner diameter ID3>inner diameter ID1). The diameter of a circle C8, which passes the outer circumferential ends 15A of the first blades 12A around the rotation axis RS as its center is referred to as an outer diameter OD3. Half of a difference between the outer diameter OD3 and the inner diameter ID1 is defined as a vane length L1b of the first blade 12A in the second section (vane length L1b=(outer diameter OD3−inner diameter ID3)/2).

In the second section, the diameter of a circle C7, which passes the inner circumferential ends 14B of the second blades 12B around the rotation axis RS as its center is referred to as an inner diameter ID4. The inner diameter ID4 is equal to the inner diameter ID3 in the second section (inner diameter ID4>inner diameter ID3). The diameter of a circle C8, which passes the outer circumferential ends 15B of the second blades 12B around the rotation axis RS as its center is referred to as an outer diameter OD4. The outer diameter O4 is equal to the outer diameter OD3 in the second section (outer diameter O4=outer diameter OD3). Half of a difference between the outer diameter OD4 and the inner diameter ID4 is defined as a vane length L2b of the second blade 12B in the second section (vane length L2b=(outer diameter OD4−inner diameter ID4)/2). The vane length L2b of the second blade 12B in the second section is equal to the vane length L1b of the first blade 12A in the second section (vane length L2b=vane length L1b).

When the first blade 12A is viewed parallel to the rotation axis RS, the first blade 12A in the second section illustrated in FIG. 11 overlaps the first blade 12A in the first section illustrated in FIG. 10 such that the first blade 12A in the second section does not protrude out from the outline of the first blade 12A in the first section. The impeller 10 is thus designed to satisfy relationships of outer diameter OD3=outer diameter OD1, inner diameter ID3≥inner diameter ID1, and vane length L1b≤vane length L1a.

Similarly, when the second blade 12B is viewed parallel to the rotation axis RS, the second blade 12B in the second section illustrated in FIG. 11 overlaps the second blade 12B in the first section illustrated in FIG. 10 such that the second blade 12B in the second section does not protrude out from the outline of the second blade 12B in the first section. The impeller 10 is thus designed to satisfy relationships of outer diameter OD4=outer diameter OD2, inner diameter ID4≥inner diameter ID2, and vane length L2b≤vane length L2a.

Here, as described above, the ratio of the inner diameter ID1 of the first blades 12A to the outer diameter OD1 of the first blades 12A is lower than or equal to 0.7. Since the blade 12 is designed to satisfy relationships of inner diameter ID3≥inner diameter ID1, inner diameter ID4≥inner diameter ID2, inner diameter ID2>inner diameter ID1, the inner diameter of the first blades 12A is defined as a blade inner diameter of the blades 12. Since the blade 12 is designed to satisfy relationships of outer diameter OD3=outer diameter OD1, outer diameter O4=outer diameter OD2, outer diameter OD2=outer diameter OD1, the outer diameter of the first blades 12A is also defined as a blade outer diameter of the blades 12. When the blades 12 included in the impeller 10 is viewed as a whole, a ratio of the inner diameter of the blades 12 to the outer diameter of the blades 12 is lower than or equal to 0.7.

The blade inner diameter of the plurality of blades 12 is a diameter of the respective inner circumferential ends of the plurality of blades 12. In other words, the blade inner diameter of the plurality of blades 12 is a diameter of the leading edges 14A1 of the plurality of blades 12. The blade outer diameter of the plurality of blades 12 is also a diameter of the respective outer circumferential ends of the plurality of blades 12. In other words, the blade outer diameter of the plurality of blades 12 is a diameter of the trailing edges 15A1 and the trailing edges 15B1 of the plurality of blades 12.

Configurations of First Blades 12A and Second Blades 12B The first blade 12A has a relationship of vane length L1a>vane length L1b in comparison between the first section illustrated in FIG. 10 and the second section illustrated in FIG. 11. In other words, the plurality of blades 12 each have a portion at which the vane length in the first region is formed greater than the vane length in the second region. More specifically, the first blade 12A has a portion at which the vane length of the first blade 12A decreases from the main plate 11 to the corresponding one of the side plates 13 in the axial direction of the rotation axis RS.

Similarly, the second blade 12B has a relationship of vane length L2a>vane length L2b in comparison between the first section illustrated in FIG. 10 and the second section illustrated in FIG. 11. In other words, the second blade 12B has a portion at which the vane length of the second blade 12B decreases from the main plate 11 to the corresponding one of the side plates 13 in the axial direction of the rotation axis RS.

As illustrated in FIG. 3, the leading edges of the first blades 12A and the second blades 12B are inclined such that the blade inner diameter increases from the main plate 11 to the corresponding one of the side plates 13. In other words, the plurality of blades 12 are formed such that the blade inner diameter is increased from the main plate 11 to the corresponding one of the side plates 13 and have inclination portions 141A, which are each inclined such that the inner circumferential ends 14A included in the leading edges 14A1 are away from the rotation axis RS. Similarly, the plurality of blades 12 are formed such that the blade inner diameter is increased from the main plate 11 to the corresponding one of the side plates 13 and have inclination portions 141B, which are each inclined such that the inner circumferential ends 14B included in the leading edges 14B1 are away from the rotation axis RS.

Sirocco Vane Portion and Turbo Vane Portion

As illustrated in FIG. 10 and FIG. 11, the first blades 12A each have a first sirocco vane portion 12A1, which includes the outer circumferential end 15A and is formed as a forward-curved blade, and a first turbo vane portion 12A2, which includes the inner circumferential end 14A and is formed as a backward-curved blade. In a radial direction of the impeller 10, the first sirocco vane portion 12A1 forms a portion of the first blade 12A that is closer to the outer circumference than is the first turbo vane portion 12A2, which forms a portion of the first blade 12A that is closer to an inner circumference than is the first sirocco vane portion 12A1. In other words, the first blade 12A is formed such that the first turbo vane portion 12A2 and the first sirocco vane portion 12A1 are arranged sequentially from the rotation axis RS toward the outer circumference in the radial direction of the impeller 10.

In the first blade 12A, the first turbo vane portion 12A2 and the first sirocco vane portion 12A1 are integrally formed with each other. The first turbo vane portion 12A2 forms the leading edge 14A1 of the first blade 12A and the first sirocco vane portion 12A1 forms the trailing edge 15A1 of the first blade 12A. The first turbo vane portion 12A2 linearly extends from the inner circumferential end 14A included in the leading edge 14A1 toward the outer circumference in a radial direction of the impeller 10.

In a radial direction of the impeller 10, a region of the first blade 12A in which the first sirocco vane portion 12A1 is located is defined as a first sirocco region 12A11 and a region of the first blade 12A in which the first turbo vane portion 12A2 is located is defined as a first turbo region 12A21. In the first blade 12A, the first turbo region 12A21 is larger than the first sirocco region 12A11 in a radial direction of the impeller 10.

In the main-plate-side blade region 122a, which is the first region, and the side-plate-side blade region 122b, which is the second region, illustrated in FIG. 9, the impeller 10 has a portion that has a relationship of first sirocco region 12A11<first turbo region 12A21 in a radial direction of the impeller 10. In the main-plate-side blade region 122a, which is the first region, and the side-plate-side blade region 122b, which is the second region, in the impeller 10 and the first blades 12A, a proportion for which the first turbo vane portion 12A2 accounts is higher in a radial direction of the impeller 10 than a proportion for which the first sirocco vane portion 12A1 accounts.

Similarly, as illustrated in FIG. 10 and FIG. 11, the second blade 12B each have a second sirocco vane portion 12B1, which includes the outer circumferential end 15B and is formed as a forward-curved blade, and a second turbo vane portion 12B2, which includes the inner circumferential end 14B and is formed as a backward-curved blade. In a radial direction of the impeller 10, the second sirocco vane portion 12B1 forms a portion of the second blade 12B that is closer to the outer circumference than is the second turbo vane portion 12B2, which forms a portion of the second blade 12B that is closer to the inner circumference than is the second sirocco vane portion 12B1. In other words, the second blade 12B is formed such that the second turbo vane portion 12B2 and the second sirocco vane portion 12B1 are arranged sequentially from the rotation axis RS toward the outer circumference in the radial direction of the impeller 10.

In the second blade 12B, the second turbo vane portion 12B2 and the second sirocco vane portion 12B1 are integrally formed with each other. The second turbo vane portion 12B2 forms the leading edge 14B1 of the second blade 12B and the second sirocco vane portion 12B1 forms the trailing edge 15B1 of the of the second blade 12B. The second turbo vane portion 12B2 linearly extends from the inner circumferential end 14B included in the leading edge 14B1 toward the outer circumference in a radial direction of the impeller 10.

In a radial direction of the impeller 10, a region of the second blade 12B in which the second sirocco vane portion 12B1 is located is defined as a second sirocco region 12B11 and a region of the second blade 12B in which the second turbo vane portion 12B2 is located is defined as a second turbo region 12B21. In the second blade 12B, the second turbo region 12B21 is larger than the second sirocco region 12B11 in a radial direction of the impeller 10.

In the main-plate-side blade region 122a, which is the first region, and the side-plate-side blade region 122b, which is the second region, illustrated in FIG. 9, the impeller 10 has a portion that has a relationship of second sirocco region 12B11<second turbo region 12B21 in a radial direction of the impeller 10. In the main-plate-side blade region 122a, which is the first region, and the side-plate-side blade region 122b, which is the second region, in the impeller 10 and the second blades 12B, a proportion for which the second turbo vane portion 12B2 accounts is higher in a radial direction of the impeller 10 than a proportion for which the second sirocco vane portion 12B1 accounts.

In the configuration described above, in the main-plate-side blade region 122a and the side-plate-side blade region 122b in the plurality of blades 12, a region in which a turbo vane portion is ranged is larger than a region in which a sirocco vane portion is ranged in a radial direction of the impeller 10. In other words, in the main-plate-side blade region 122a and the side-plate-side blade region 122b, the plurality of blades 12 have a portion in which a proportion for which a turbo vane portion accounts is higher in a radial direction of the impeller 10 than a proportion for which a sirocco vane portion accounts and thus has a portion that has a relation of sirocco portion<turbo portion. In other words, the plurality of blades 12 each have a portion in which the proportion for which the turbo vane portion accounts is higher in the radial direction than the proportion for which the sirocco vane portion accounts in the first region and the second region. Such a relationship on the proportion for which the sirocco vane portion accounts and the proportion for which the turbo vane portion accounts in a radial direction from the rotation axis RS may also be satisfied through all regions of the main-plate-side blade region 122a, which is the first region, and the side-plate-side blade region 122b, which is the second region.

Through all regions of the main-plate-side blade region 122a and the side-plate-side blade region 122b, the plurality of blades 12 are not limited to the ones in which a proportion for which a turbo vane portion accounts is higher in a radial direction of the impeller 10 than a proportion for which a sirocco vane portion accounts and is not limited to have a relation of sirocco portion<turbo portion. The plurality of blades 12 may also be each formed such that the proportion for which the sirocco vane portion accounts is lower in the radial direction than or equal to the proportion for which the turbo vane portion accounts in the first region and the second region.

Outlet Angle

As illustrated in FIG. 10, an outlet angle at the first sirocco vane portion 12A1 included in the first blade 12A in the first section is defined as an outlet angle α1. The outlet angle α1 refers to an angle located at an intersection of a circular arc of the circle C3 centered on the rotation axis RS and the outer circumferential end 15A and formed between a tangent line TL1 of the circle and a center line CL1 of the first sirocco vane portion 12A1 at the outer circumferential end 15A. This outlet angle α1 is larger than 90 degrees.

An outlet angle at the second sirocco vane portion 12B1 included in the second blade 12B in the first section is defined as an outlet angle α2. The outlet angle α2 refers to an angle located at an intersection of a circular arc of the circle C3 centered on the rotation axis RS and the outer circumferential end 15B and formed between a tangent line TL2 of the circle and a center line CL2 of the second sirocco vane portion 12B1 at the outer circumferential end 15B. The outlet angle α2 is larger than 90 degrees.

The outlet angle α2 at the second sirocco vane portion 12B1 is equal to the outlet angle α1 at the first sirocco vane portion 12A1 (outlet angle α2=outlet angle α1). When the first sirocco vane portion 12A1 and the second sirocco vane portion 12B1 are viewed parallel to the rotation axis RS, the first sirocco vane portion 12A1 and the second sirocco vane portion 12B1 are each arcuate and convex and protrude in a direction opposite to the rotation direction R.

As illustrated in FIG. 11, also in the second section of the impeller 10, the outlet angle α1 at the first sirocco vane portion 12A1 is equal to the outlet angle α2 at the second sirocco vane portion 12B1. In other words, the plurality of blades 12 each have the sirocco vane portion located from the main plate 11 and the corresponding one of the side plates 13 and formed as a forward-curved blade at which the outlet angle is formed larger than 90 degrees.

As illustrated in FIG. 10, an outlet angle at the first turbo vane portion 12A2 included in the first blade 12A in the first section is defined as an outlet angle β1. The outlet angle β1 refers to an angle located at an intersection of a circular arc of the circle C4 centered on the rotation axis RS and the first turbo vane portion 12A2 and formed between a tangent line TL3 of the circle and a center line CL3 of the first turbo vane portion 12A2. This outlet angle β1 is smaller than 90 degrees.

An outlet angle at the second turbo vane portion 12B2 included in the second blade 12B in the first section is defined as an outlet angle β2. The outlet angle β2 refers to an angle located at an intersection of a circular arc of the circle C4 centered on the rotation axis RS and the second turbo vane portion 12B2 and formed between a tangent line TL4 of the circle and a center line CL4 of the second turbo vane portion 12B2. The outlet angle β2 is smaller than 90 degrees.

The outlet angle β2 at the second turbo vane portion 12B2 is equal to the outlet angle β1 at the first turbo vane portion 12A2 (outlet angle 12=outlet angle β1).

An illustration is not provided in FIG. 11 that, also in the second section of the impeller 10, the outlet angle β1 at the first turbo vane portion 12A2 is equal to the outlet angle β2 at the second turbo vane portion 12B2. The outlet angle β1 and the outlet angle β2 are also each smaller than 90 degrees.

Radial Vane Portion

As illustrated in FIG. 10 and FIG. 11, the first blades 12A each have a first radial vane portion 12A3, which connects between the corresponding one of the first turbo vane portions 12A2 and the corresponding one of the first sirocco vane portions 12A1. The first radial vane portion 12A3 is formed as a radial vane that linearly extends in a radial direction of the impeller 10.

Similarly, the second blades 12B each have a second radial vane portion 12B3, which connects between the corresponding one of the second turbo vane portions 12B2 and the corresponding one of the second sirocco vane portions 12B1. The second radial vane portion 12B3 is formed as a radial vane that linearly extends in a radial direction of the impeller 10.

The vane angle of the first radial vane portion 12A3 and the vane angle of the second radial vane portion 12B3 are each 90 degrees. More specifically, an angle formed between a tangent line at an intersection of a center line of the first radial vane portion 12A3 and the circle C5 centered on the rotation axis RS and the center line of the first radial vane portion 12A3 is 90 degrees. An angle formed between a tangent line at an intersection of a center line of the second radial vane portion 12B3 and the circle C5 centered on the rotation axis RS and the center line of the second radial vane portion 12B3 is also 90 degrees.

Vane Interval

When the interval between two blades 12 of the plurality of blades 12 that are next to each other in the circumferential direction CD is defined as an vane interval, as illustrated in FIG. 10 and FIG. 11, the vane intervals of the plurality of blades 12 each expand from the corresponding one of the leading edges 14A1 toward the corresponding one of the trailing edges 15A1. Similarly, the vane intervals of the plurality of blades 12 each expand from the corresponding one of the leading edges 14B1 toward the corresponding one of the trailing edges 15B1.

Specifically, the vane intervals of the turbo vane portions, which include the first turbo vane portions 12A2 and the second turbo vane portions 12B2, each expand from the inner circumference to the outer circumference. In other words, the vane intervals of the turbo vane portions of the impeller 10 each expand from the inner circumference to the outer circumference. The vane intervals of the sirocco vane portions, which include the first sirocco vane portions 12A1 and the second sirocco vane portions 12B1, each are wider than the vane interval of the turbo vane portions and expand from the inner circumference to the outer circumference.

In other words, the vane interval between each of the first turbo vane portions 12A2 and the corresponding one of the second turbo vane portions 12B2 expands from the inner circumference to the outer circumference. The vane interval between any ones of the second turbo vane portions 12B2 that are next to each other also expands from the inner circumference to the outer circumference. The vane interval between each of the first sirocco vane portions 12A1 and the corresponding one of the second sirocco vane portions 12B1 is also wider than the vane interval of the turbo vane portions and expands from the inner circumference to the outer circumference. The vane interval between any ones of the second sirocco vane portions 12B1 that are next to each other is also wider than the vane interval of the turbo vane portions and expands from the inner circumference to the outer circumference.

Relationship Between Impeller 10 and Scroll Casing 40

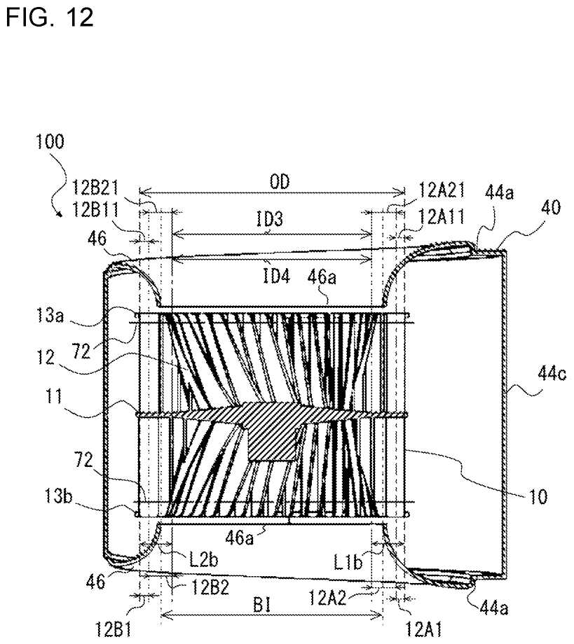

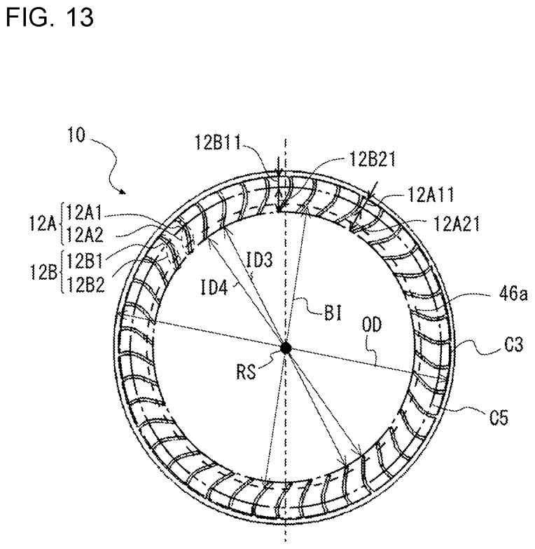

FIG. 12 is a schematic view that illustrates a relationship between the impeller 10 and the scroll casing 40 included in the centrifugal air-sending device 100 illustrated in FIG. 2 with the centrifugal air-sending device 100 viewed in a section taken along line A-A. FIG. 13 is a schematic view that illustrates a relationship between the blades 12 and the bell mouth 46 with the impeller 10 illustrated in FIG. 12 viewed parallel to the rotation axis RS. As illustrated in FIG. 12 and FIG. 13, the blade outer diameter OD of the respective outer circumferential ends of the plurality of blades 12 is larger than an inner diameter BI of the bell mouth 46 included in the scroll casing 40. The blade outer diameter OD of the plurality of blades 12 is equal to the outer diameter OD1 and the outer diameter OD2 of the first blades 12A illustrated in FIG. 10 and the outer diameter OD3 and the outer diameter O4 of the second blades 12B illustrated in FIG. 11 (blade outer diameter OD=outer diameter OD1=outer diameter OD2=outer diameter OD3=outer diameter OD4).

The impeller 10 has a portion in which the first turbo region 12A21 is larger than the first sirocco region 12A11 in the radial direction from the rotation axis RS. In other words, the impeller 10 and the plurality of first blades 12A have a portion in which a proportion for which the first turbo vane portion 12A2 accounts is higher in the radial direction from the rotation axis RS than a proportion for which the first sirocco vane portion 12A1 accounts and thus have a portion that has a relation of first sirocco vane portion 12A1<first turbo vane portion 12A2. Such a relationship on the proportion for which the first sirocco vane portion 12A1 accounts and the proportion for which the first turbo vane portion 12A2 accounts in a radial direction from the rotation axis RS may also be satisfied through all regions of the main-plate-side blade region 122a, which is the first region, and the side-plate-side blade region 122b, which is the second region.

The impeller 10 and the plurality of first blades 12A are not limited to the ones in which a proportion for which the first turbo vane portion 12A2 accounts is higher in a radial direction from the rotation axis RS than a proportion for which the first sirocco vane portion 12A1 accounts and thus have a relation of first sirocco vane portion 12A1<first turbo vane portion 12A2. The impeller 10 and the first blades 12A may also be formed such that a proportion for which the first turbo vane portion 12A2 accounts is lower in a radial direction from the rotation axis RS than or equal to a proportion for which the first sirocco vane portion 12A1 accounts.

Similarly, the impeller 10 has a portion in which the second turbo region 12B21 is larger than the second sirocco region 12B11 in the radial direction from the rotation axis RS. In other words, the impeller 10 and the second blades 12B have a portion in which a proportion for which the second turbo vane portion 12B2 accounts is higher in a radial direction from the rotation axis RS than a proportion for which the second sirocco vane portion 12B1 accounts and thus have a portion that has a relation of second sirocco vane portion 12B1<second turbo vane portion 12B2. Such a relationship on the proportion for which the second sirocco vane portion 12B1 and the proportion for which the second turbo vane portion 12B2 accounts in a radial direction from the rotation axis RS may also be satisfied through all regions of the main-plate-side blade region 122a, which is the first region, and the side-plate-side blade region 122b, which is the second region.

The impeller 10 and the second blades 12B are not limited to the ones in which a proportion for which the second turbo vane portion 12B2 accounts is higher in a radial direction from the rotation axis RS than a proportion for which the second sirocco vane portion 12B1 accounts and thus have a relation of second sirocco vane portion 12B1<second turbo vane portion 12B2. The impeller 10 and the second blades 12B may also be formed such that a proportion for which the second turbo vane portion 12B2 accounts is lower in a radial direction centered on the rotation axis RS than or equal to a proportion for which the second sirocco vane portion 12B1 accounts.

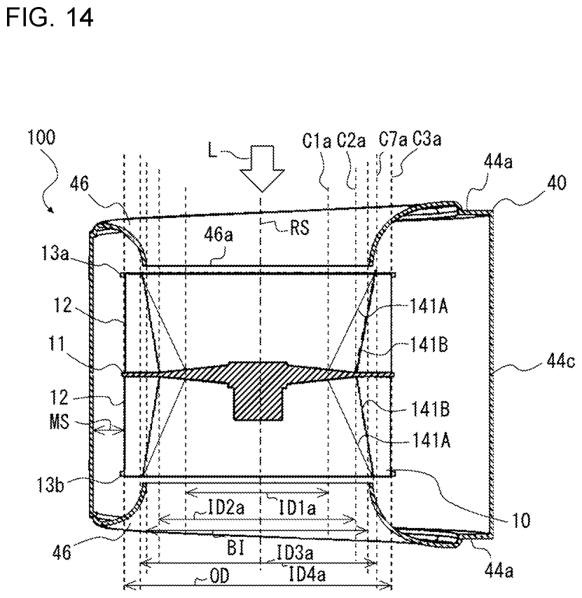

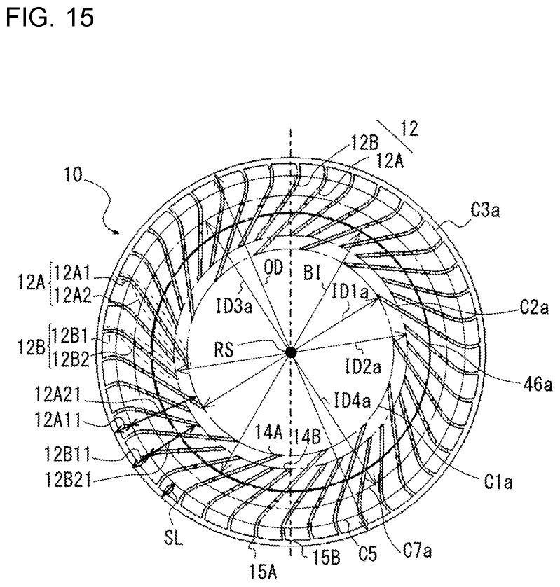

FIG. 14 is a schematic view that illustrates a relationship between the impeller 10 and the scroll casing 40 included in the centrifugal air-sending device 100 illustrated in FIG. 2 with the centrifugal air-sending device 100 viewed in the section taken along line A-A. FIG. 15 is a schematic view that illustrates a relationship between the blades 12 and the bell mouth 46 with the impeller 10 illustrated in FIG. 14 viewed parallel to the rotation axis RS. An open arrow L illustrated in FIG. 14 represents a direction in which the impeller 10 is viewed parallel to the rotation axis RS.

As illustrated in FIG. 14 and FIG. 15, a circle is defined as a circle Cia that passes the inner circumferential ends 14A of the plurality of first blades 12A centered on the rotation axis RS at a connection position at which the first blades 12A and the main plate 11 are connected to each other when the circle is viewed parallel to the rotation axis RS. The diameter of the circle CIa, that is, an inner diameter of the first blades 12A at the connection position, at which the first blades 12A and the main plate 11 are connected to each other, is defined as an inner diameter IDia.

A circle is also defined as a circle C2a that passes the inner circumferential ends 14B of the plurality of second blades 12B centered on the rotation axis RS at a connection position at which the second blades 12B and the main plate 11 are connected to each other when the circle is viewed parallel to the rotation axis RS. The diameter of the circle C2a, that is, an inner diameter of the second blades 12B at the connection position, at which the first blades 12A and the main plate 11 are connected to each other, is defined as an inner diameter ID2a. The inner diameter ID2a is larger than the inner diameter ID1a (inner diameter ID2a>inner diameter ID1a).

When the circle C3a is viewed parallel to the rotation axis RS, the diameter of the circle C3a, which passes the outer circumferential ends 15A of the plurality of first blades 12A and the outer circumferential ends 15B of the second blades 12B around the rotation axis RS as its center, that is, the outer diameter of the plurality of blades 12 is also referred to as a blade outer diameter OD.

A circle is also defined as a circle C7a that passes the inner circumferential ends 14A of the plurality of first blades 12A centered on the rotation axis RS at a connection position at which the first blades 12A and the corresponding one of the side plates 13 are connected to each other when the circle is viewed parallel to the rotation axis RS. The diameter of the circle C7a, that is, an inner diameter of the first blades 12A at the connection position, at which the first blades 12A and the corresponding one of the side plates 13 are connected to each other, is defined as an inner diameter ID3a.

A circle is also defined as a circle C7a that passes the inner circumferential ends 14B of the plurality of second blades 12B centered on the rotation axis RS at a connection position at which the second blades 12B and the corresponding one of the side plates 13 are connected to each other when the circle is viewed parallel to the rotation axis RS. The diameter of the circle C7a, that is, an inner diameter of the second blades 12B at the connection position, at which the second blades 12B and the corresponding one of the side plates 13 are connected to each other, is defined as an inner diameter ID4a.

As illustrated in FIG. 14 and FIG. 15, when the bell mouth 46 is viewed parallel to the rotation axis RS, the position of the inner diameter BI of the bell mouth 46 is located between the inner diameter ID1a of the first blades 12A, which is at the main plate 11, and the inner diameter ID3 of the first blades 12A, which is at the corresponding one of the side plates 13, and in the regions of the first turbo vane portions 12A2 and the second turbo vane portions 12B2. More specifically, the inner diameter BI of the bell mouth 46 is larger than the inner diameter ID1a of the first blades 12A, which is at the main plate 11, and smaller than the inner diameter ID3a of the first blades 12A, which is at the corresponding one of the side plates 13.

In other words, the inner diameter BI of the bell mouth 46 is larger than the blade inner diameter of the plurality of blades 12 that is at the main plate 11 and smaller than the blade inner diameter of the plurality of blades 12 that is at the corresponding one of the side plates 13. In other words, when the inner circumferential edge portion 46a is viewed parallel to the rotation axis RS, the inner circumferential edge portion 46a, which forms the inner diameter BI of the bell mouth 46, is located between the circle Cia and the circle C7a and in the regions of the first turbo vane portions 12A2 and the second turbo vane portions 12B2.

As illustrated in FIG. 14 and FIG. 15, when the bell mouth 46 is viewed parallel to the rotation axis RS, the position of the inner diameter BI of the bell mouth 46 is located between the inner diameter ID2a of the second blades 12B, which is at the main plate 11, and the inner diameter ID4a of the second blades 12B, which is at the corresponding one of the side plates 13, and in the regions of the first turbo vane portions 12A2 and the second turbo vane portions 12B2. More specifically, the inner diameter BI of the bell mouth 46 is larger than the inner diameter ID2a of the second blades 12B, which is at the main plate 11, and smaller than the inner diameter ID4a of the second blades 12B, which is at the corresponding one of the side plates 13.

In other words, the inner diameter BI of the bell mouth 46 is larger than the blade inner diameter of the plurality of blades 12 that is at the main plate 11 and smaller than the blade inner diameter of the plurality of blades 12 that is at the corresponding one of the side plates 13. More specifically, the inner diameter BI of the bell mouth 46 is larger than the blade inner diameter of the respective inner circumferential ends of the plurality of blades 12 in the first region and smaller than the blade inner diameter of the respective inner circumferential ends of the plurality of blades 12 in the second region. In other words, when the inner circumferential edge portion 46a is viewed parallel to the rotation axis RS, the inner circumferential edge portion 46a, which forms the inner diameter BI of the bell mouth 46, is located between the circle C2a and the circle C7a and in the regions of the first turbo vane portions 12A2 and the second turbo vane portions 12B2.

As illustrated in FIG. 14 and FIG. 15, a radial length of each of the first sirocco vane portions 12A1 and the second sirocco vane portions 12B1 in a radial direction of the impeller 10 is defined as a distance SL. The closest-approach distance between which the plurality of blades 12 in the impeller 10 are closest to the circumferential wall 44c of the scroll casing 40, in the centrifugal air-sending device 100 is also defined as a distance MS. In this case, the distance MS in the centrifugal air-sending device 100 is larger than twice the distance SL (distance MS>distance SL×2). The distance MS, which is marked in the section of the centrifugal air-sending device 100 taken along line A-A illustrated in FIG. 14, is the closest-approach distance between which the plurality of blades 12 are closest to the circumferential wall 44c of the scroll casing 40 and is not necessarily marked in the section taken along line A-A.

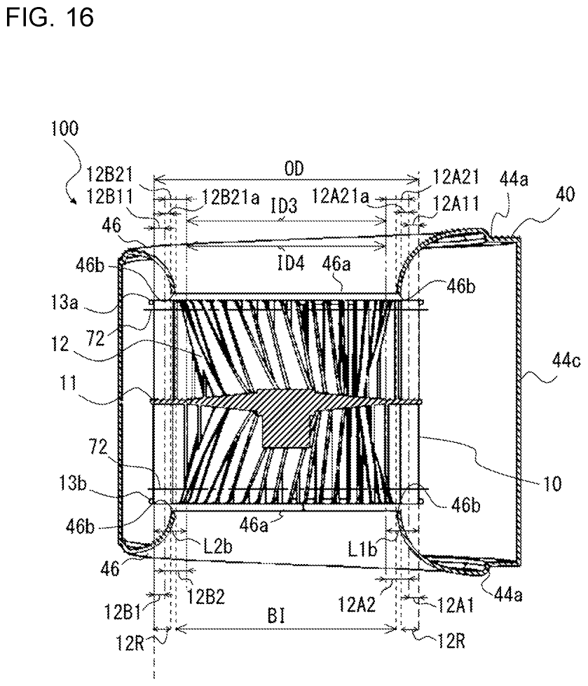

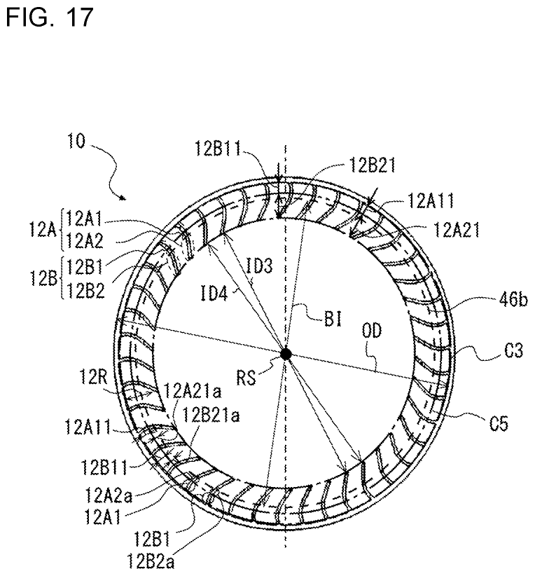

FIG. 16 is a schematic view that illustrates a relationship between the impeller 10 and the bell mouth 46 included in the centrifugal air-sending device 100 illustrated in FIG. 2 with the centrifugal air-sending device 100 viewed in the section taken along line A-A. FIG. 17 is a schematic view that illustrates a relationship between the blades 12 and the bell mouth 46 with the impeller 10 illustrated in FIG. 16 viewed in a second section and viewed parallel to the rotation axis RS. The blades 12 located outside the inner diameter BI of the bell mouth 46 are across the first sirocco vane portions 12A1 and the first turbo vane portion 12A2. The blades 12 located outside the inner diameter BI of the bell mouth 46 are also across the second sirocco vane portions 12B1 and the second turbo vane portions 12B2.

In addition, when the bell mouth 46 is viewed parallel to the rotation axis RS, a region of portions of the plurality of blades 12 located closer to the outer circumference than is an inner circumferential side end portion 46b, which is an inner circumferential end portion of the bell mouth 46 in the radial directions from the rotation axis RS, is defined as an outer circumferential region 12R. The impeller 10 is formed such that the proportion for which the first sirocco vane portion 12A1 accounts is higher than or equal to the proportion for which the first turbo vane portion 12A2 accounts in the outer circumferential region 12R. In other words, when the first sirocco region 12A11 is viewed parallel to the rotation axis RS, in the outer circumferential region 12R, which is located closer to the outer circumference than is the inner circumferential side end portion 46b of the bell mouth 46, the first sirocco region 12A11 is larger than the first turbo region 12A21a in the radial directions from the rotation axis RS. The inner circumferential side end portion 46b is ring-shaped centered on the rotation axis RS and forms the inner circumferential edge portion 46a.

When the first turbo region 12A21a is viewed parallel to the rotation axis RS, the first turbo region 12A21a is a region in the first turbo region 12A21 and closer to the outer circumference than is the inner circumferential side end portion 46b of the bell mouth 46. When the first turbo vane portions 12A2 that define the first turbo region 12A21a are defined as first turbo vane portions 12A2a, the outer circumferential region 12R of the impeller 10 preferably has the proportion for which the first sirocco vane portion 12A1 accounts larger than or equal to the proportion for which the first turbo vane portion 12A2a accounts. Such a relationship on the proportion for which the first sirocco vane portion 12A1 and the proportion for which the first turbo vane portion 12A2a accounts in the outer circumferential region 12R may also be satisfied through all regions of the main-plate-side blade region 122a, which is the first region, and the side-plate-side blade region 122b, which is the second region.

The impeller 10 is further preferably formed such that the proportion for which the second sirocco vane portion 12B1 accounts is higher than or equal to the proportion for which the second turbo vane portion 12B2 accounts in the outer circumferential region 12R. In other words, when the impeller 10 is viewed parallel to the rotation axis RS, in the outer circumferential region 12R of the impeller 10, which is located closer to the outer circumference than is the inner circumferential side end portion 46b of the bell mouth 46, the second sirocco region 12B11 is larger than the second turbo region 12B21a in the radial direction from the rotation axis RS.

When the second turbo region 12B21a is viewed parallel to the rotation axis RS, the second turbo region 12B21a is a region in the second turbo region 12B21 and closer to the outer circumference than is the inner circumferential side end portion 46b of the bell mouth 46. When the second turbo vane portions 12B2 that define the second turbo region 12B21a are defined as second turbo vane portions 12B2a, the outer circumferential region 12R of the impeller 10 preferably has the proportion for which the second sirocco vane portions 12B1 account larger than or equal to the proportion for which the second turbo vane portions 12B2a account. Such a relationship on the proportion for which the second sirocco vane portion 12B1 and the proportion for which the second turbo vane portion 12B2a accounts in the outer circumferential region 12R may also be satisfied through all regions of the main-plate-side blade region 122a, which is the first region, and the side-plate-side blade region 122b, which is the second region.

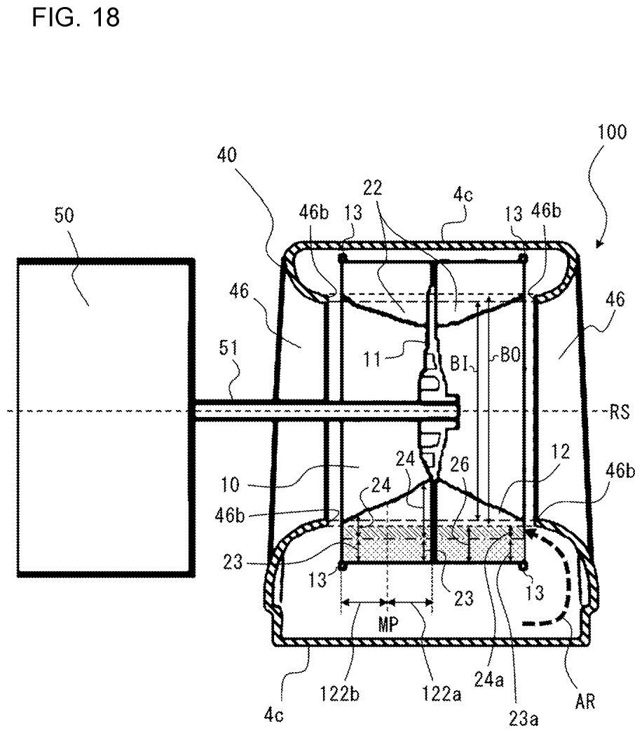

FIG. 18 is a conceptual view that illustrates a relationship between the impeller 10 and the bell mouth 46 illustrated in FIG. 16 and FIG. 17. As illustrated in FIG. 18, the blades 12 have blade inner portions 22, which extend further inward than the inner circumferential side end portion 46b of the bell mouth 46 in the radial directions from the rotation axis RS. The blade inner portions 22 are located at regions of the plurality of blades 12 in which the inner diameter BI of the bell mouth 46 is located.

The plurality of blades 12 each have the vane length in the first region, which is formed greater than the vane length in the second region. The plurality of blades 12 also each have, in the vane length of the blades 12 in the radial direction, a portion in which the proportion for which the turbo vane portion 24 accounts is higher in a radial direction than the proportion for which the sirocco vane portion 23 accounts in any of the first region and the second region. As described above, the first region is the main-plate-side blade region 122a and the second region is the side-plate-side blade region 122b.

In the radial directions, portions of the plurality of blades 12 that are further outside than is an outer diameter BO of the inner circumferential side end portion 46b of the bell mouth 46 is defined as an blade outer circumferential portion 26. The blade outer circumferential portion 26 is formed such that the proportion for which the sirocco vane portion 23 accounts is higher in the radial direction than or equal to the proportion for which the turbo vane portion 24 accounts in any of the first region and the second region. In other words, as illustrated in FIG. 18, in the radial length of the blades 12, the proportion for which an outer sirocco vane portion 23a, which is located further outside than is the outer diameter of the inner circumferential side end portion 46b of the bell mouth 46, accounts is specified to be higher than or equal to the proportion for which an outer turbo vane portion 24a accounts.

The first sirocco vane portions 12A1 and the second sirocco vane portions 12B1 are collectively referred to as the sirocco vane portions 23 illustrated in FIG. 18. The first turbo vane portions 12A2 and the second turbo vane portions 12B2 are collectively referred to as the turbo vane portions 24 illustrated in FIG. 18. The first sirocco vane portions 12A1 and the second sirocco vane portions 12B1, which are further outside than is the inner circumferential side end portion 46b of the bell mouth 46 when the sirocco vane portions are viewed parallel to the rotation axis RS, are collectively referred to as the outer sirocco vane portions 23a illustrated in FIG. 18. The outer turbo vane portions 24a are also portions of the first turbo vane portions 12A2 and the second turbo vane portions 12B2 that are closer to the outer circumference than is the inner circumferential side end portion 46b of the bell mouth 46 when the turbo vane portions are viewed parallel to the rotation axis RS. The first turbo vane portions 12A2a and the second turbo vane portions 12B2a are also collectively referred to as the outer turbo vane portions 24a.

[Operation of Centrifugal Air-Sending Device 100]

Operation of the centrifugal air-sending device is described below with reference to FIG. 18. When the motor 50 operates, the plurality of blades 12 in the centrifugal air-sending device 100 rotate about the rotation axis RS through a motor shaft 51 and the main plate 11. Air outside the scroll casing 40 of the centrifugal air-sending device 100 is thus sucked from the casing suction ports 45 into the impeller 10 and blown out from the impeller 10 into the scroll casing 40 through pressure-rising action performed by the impeller 10. The air blown out from the impeller 10 into the scroll casing 40 is decelerated at an expansion air passage partly defined by the circumferential wall 44c of the scroll casing 40, recovers static pressure, and is blown out from the discharge port 42a illustrated in FIG. 1 to the outside.

[Advantageous Effects of Centrifugal Air-Sending Device 100]

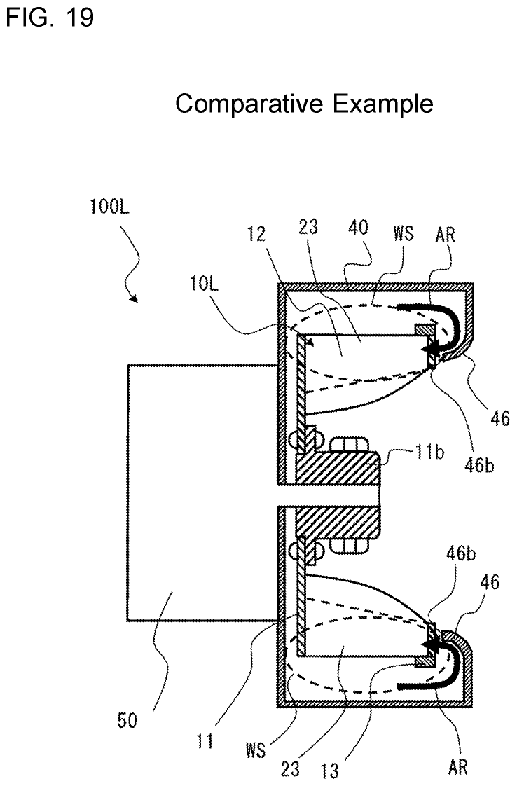

FIG. 19 is a sectional view that illustrates a centrifugal air-sending device 100L according to a comparative example. In the centrifugal air-sending device 100L according to the comparative example, portions of the blades 12 that are indicated by a region WS and located further outside than is the inner circumferential side end portion 46b of the bell mouth 46 are only portions formed as sirocco vane portions 23. An airflow AR that is blown out from an impeller 10L and passes along the inner wall surface of the bell mouth 46 thus collides with portions of the sirocco vane portions 23, which each have a large outlet angle and at which the airflow passes at increased inflow velocity when the airflow passes into the impeller 10L again. The airflow AR that collides with the sirocco vane portions 23 thus causes noise generated from the centrifugal air-sending device 100L and deterioration in input.

On the other hand, the blade outer circumferential portion 26 in the centrifugal air-sending device 100 according to Embodiment 1 is formed such that the proportion for which the sirocco vane portion 23 accounts is higher in the radial direction than or equal to the proportion for which the turbo vane portion 24 accounts in the first region and the second region. The centrifugal air-sending device 100, which has the configuration described above, is configured to further increase a pressure of an airflow blown out from the impeller 10 and an air volume in comparison with a centrifugal air-sending device that does not have the configuration described above. The centrifugal air-sending device 100 has an increased proportion for which the sirocco vane portions 23 account and is thus configured to further increase dynamic pressure and thus increase both the air volume of an airflow and the pressure of the airflow. In the centrifugal air-sending device 100, which has the configuration described above, an airflow AR that passes along an inner wall surface of the bell mouth 46 passes into the impeller 10 again thus collides with the turbo vane portions 24, which each have a small outlet angle and at which the airflow passes at decreased inflow velocity. As a result, in the centrifugal air-sending device 100, when the airflow that passes along the inner wall surface of the bell mouth 46 passes into the impeller 10 again, noise generated from the airflow is thus prevented and deterioration in input is prevented as well. The centrifugal air-sending device 100 allows an airflow to pass into the turbo vane portions 24 when the airflow passes into the impeller 10 again and thus reduces loss at a time when the airflow collides with the blades 12 and resistance at a time when the impeller 10 rotates. Input is thus reduced.

The centrifugal air-sending device according to Embodiment 1, in which the proportion for which the sirocco vane portion 23 accounts is higher than or equal to the proportion for which the turbo vane portion 24 accounts at portions of the plurality of blades 12 that are further outside than is the inner circumferential side end portion 46b of the bell mouth 46, is also configured to increase pressure and an air volume.

### Embodiment 2

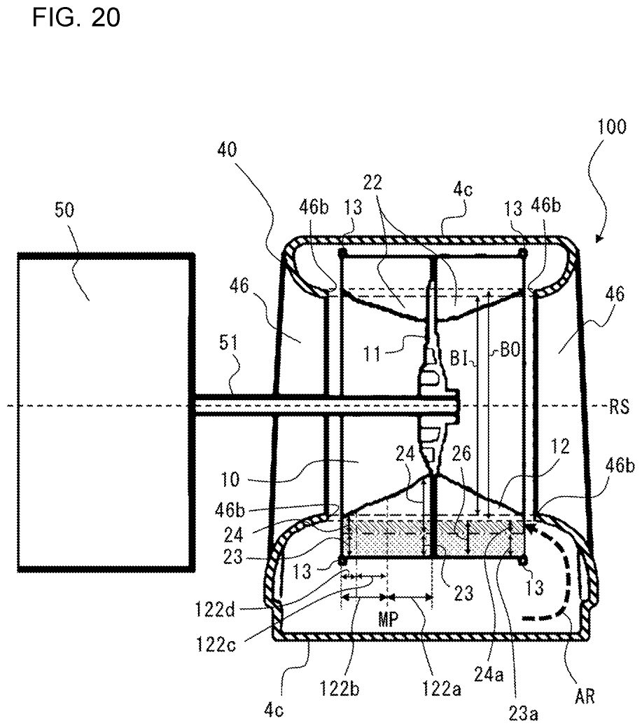

FIG. 20 is a sectional view that schematically illustrates a centrifugal air-sending device 100 according to Embodiment 2. Components that are the same in configuration as those of the centrifugal air-sending device 100 or other devices illustrated in FIG. 1 to FIG. 18 are given the same reference signs and description of such components is omitted. The centrifugal air-sending device 100 according to Embodiment 2 is to be further specified in relationship between the impeller 10 and the scroll casing 40 included in the centrifugal air-sending device 100 according to Embodiment 1.

The blades 12 of the impeller 10 have a third region 122c and a fourth region 122d.

The third region 122c is in the side-plate-side blade region 122b, which is the second region, and is a portion in which the proportion for which the turbo vane portion 24 accounts is higher in the radial direction than the proportion for which the sirocco vane portion 23 accounts. The fourth region 122d is in the side-plate-side blade region 122b, which is the second region, and is a portion in which the proportion for which the turbo vane portion 24 accounts is lower in the radial direction than the proportion for which the sirocco vane portion 23 accounts.

The third region 122c is closer to the main plate 11 than is the fourth region 122d in the axial direction of the rotation axis RS. The fourth region 122d is closer to the corresponding one of the side plates 13 than is the third region 122c in the axial direction of the rotation axis RS. The impeller 10 is formed such that, in the side-plate-side blade region 122b, which is the second region, the proportion for which the third region 122c accounts in the axial direction of the rotation axis RS is higher in the axial direction of the rotation axis RS than the proportion for which the fourth region 122d accounts.

[Advantageous Effects of Centrifugal Air-Sending Device 100]

The centrifugal air-sending device 100 according to Embodiment 2 has the third region 122c and the fourth region 122d in the side-plate-side blade region 122b, which is the second region. The centrifugal air-sending device 100 according to Embodiment 2, which has a proportion for which the sirocco vane portions 23 that is increased from the main plate 11 to the corresponding one of the side plates 13, is configured to further increase pressure and an air volume in comparison with the centrifugal air-sending device 100 according to Embodiment 1. The centrifugal air-sending device 100 according to Embodiment 2, which has the same configuration as the centrifugal air-sending device 100 according to Embodiment 1, is also configured to produce the same effects as the centrifugal air-sending device 100 according to Embodiment 1.

### Embodiment 3

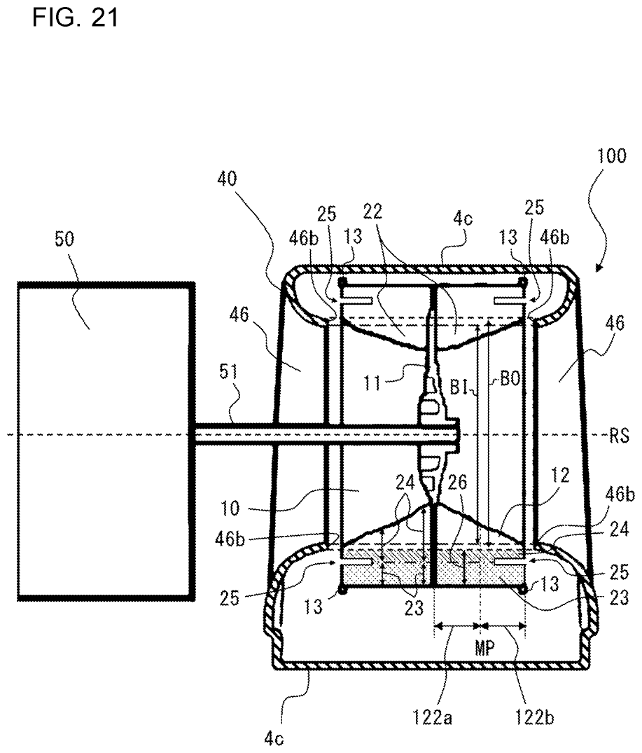

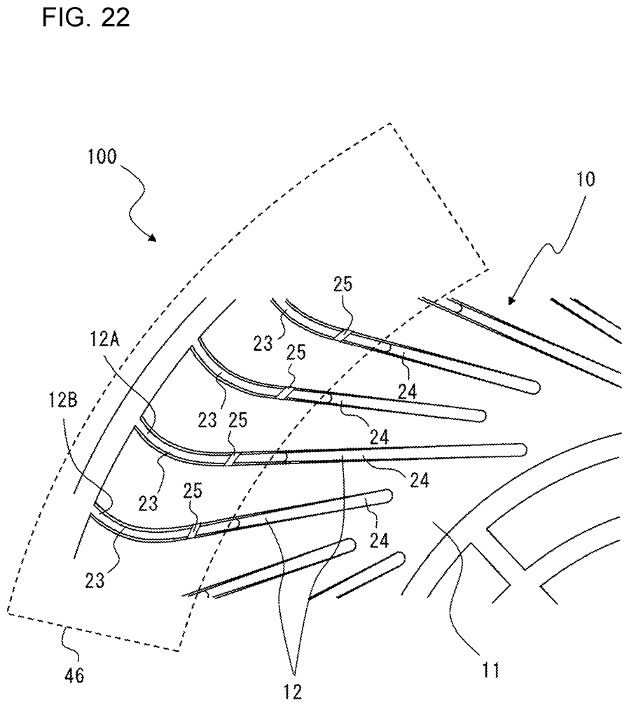

FIG. 21 is a sectional view that schematically illustrates a centrifugal air-sending device 100 according to Embodiment 3. FIG. 22 is an enlarged view that illustrates a portion of the impeller 10 included in the centrifugal air-sending device 100 according to Embodiment 3 that is in range E in the impeller 10 illustrated in FIG. 6. Components that are the same in configuration as those of the centrifugal air-sending device 100 or other devices illustrated in FIG. 1 to FIG. 20 are given the same reference signs and description of such components is omitted. The centrifugal air-sending device 100 according to Embodiment 3 is to be further specified in configuration of the impeller 10 included in the centrifugal air-sending device 100 according to Embodiment 1 and Embodiment 2.

As illustrated in FIG. 21 and FIG. 22, the blades 12 have the turbo vane portions 24 and the sirocco vane portions 23 separated from each other in the side-plate-side blade region 122b, which is the second region. The blades 12 have separation portions 25 between the turbo vane portions 24 and the sirocco vane portions 23 in the radial directions centered on the rotation axis RS.

The separation portions 25 are each a through-hole that passes through the blades 12 in the radial directions centered on the rotation axis RS. The separation portions 25 are portions that are recessed from ends of the blades 12 located closest to the corresponding one of the side plates 13 toward the main plate 11 in the axial direction of the rotation axis RS. The separation portions 25 are opened only in the side-plate-side blade region 122b, which is the second region.

[Advantageous Effects of Centrifugal Air-Sending Device 100]

The centrifugal air-sending device 100 according to Embodiment 3, in which the turbo vane portions 24 and the sirocco vane portions 23 are separated from each other, is configured to reduce loss caused by an airflow that passes into the sirocco vane portions 23. After an airflow leaks from the turbo vane portions 24, which are separated from the sirocco vane portions 23, and passes behind the turbo vane portions 24, the airflow is recovered at the sirocco vane portions 23, which are located behind the turbo vane portions 24, and loss is thus reduced. The centrifugal air-sending device 100 according to Embodiment 3, which has the same configuration as the centrifugal air-sending device 100 according to Embodiment 1, is also configured to produce the same effects as the centrifugal air-sending device 100 according to Embodiment 1.

### Embodiment 4

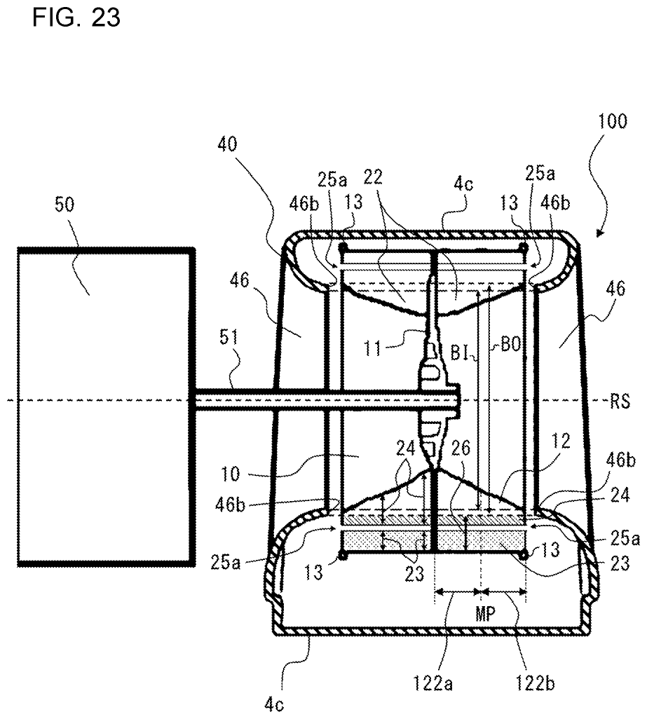

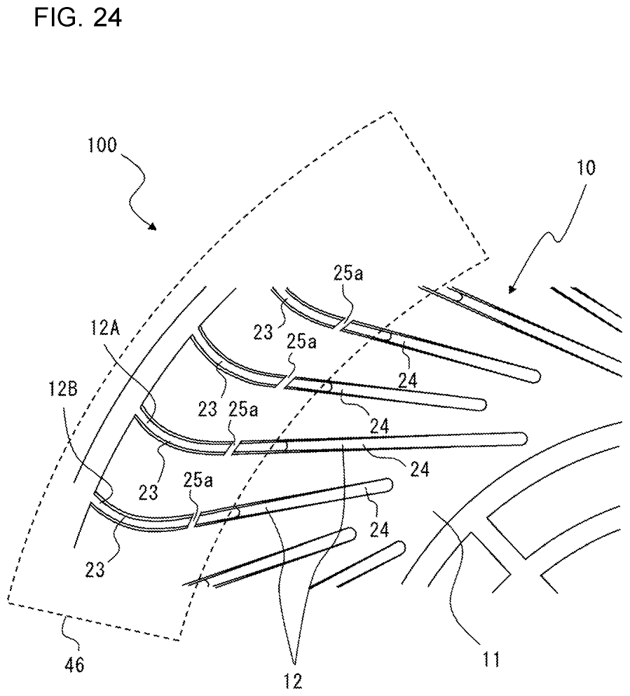

FIG. 23 is a sectional view that schematically illustrates a centrifugal air-sending device 100 according to Embodiment 4. FIG. 24 is an enlarged view that illustrates a portion of the impeller 10 included in the centrifugal air-sending device 100 according to Embodiment 4 that is in range E in the impeller 10 illustrated in FIG. 6. Components that are the same in configuration as those of the centrifugal air-sending device 100 or other devices illustrated in FIG. 1 to FIG. 22 are given the same reference signs and description of such components is omitted. The centrifugal air-sending device 100 according to Embodiment 4 is to be further specified in configuration of the impeller 10 included in the centrifugal air-sending device 100 according to Embodiment 3.

As illustrated in FIG. 23 and FIG. 24, the blades 12 have the turbo vane portions 24 and the sirocco vane portions 23 separated from each other in the main-plate-side blade region 122a, which is the first region, and the side-plate-side blade region 122b, which is the second region. The blades 12 have separation portions 25a between the turbo vane portions 24 and the sirocco vane portions 23 in the radial directions centered on the rotation axis RS.

The separation portions 25a are each a through-hole that passes through the blades 12 in the radial directions centered on the rotation axis RS. The separation portions 25a are portions that are recessed from ends of the blades 12 located closest to the corresponding one of the side plates 13 toward the main plate 11 in the axial direction of the rotation axis RS. The separation portions 25a are opened in the main-plate-side blade region 122a, which is the first region, and the side-plate-side blade region 122b, which is the second region. The bottom portions of the separation portions 25a in the axial direction of the rotation axis RS may also be located at the main plate 11.

[Advantageous Effects of Centrifugal Air-Sending Device 100]

The centrifugal air-sending device 100 according to Embodiment 4, in which the turbo vane portions 24 and the sirocco vane portions 23 are separated from each other, is configured to reduce loss caused by an airflow that passes into the sirocco vane portions 23. The centrifugal air-sending device 100 according to Embodiment 4, which has the same configuration as the centrifugal air-sending device 100 according to Embodiment 1, is also configured to produce the same effects as the centrifugal air-sending device 100 according to Embodiment 1.

### Embodiment 5

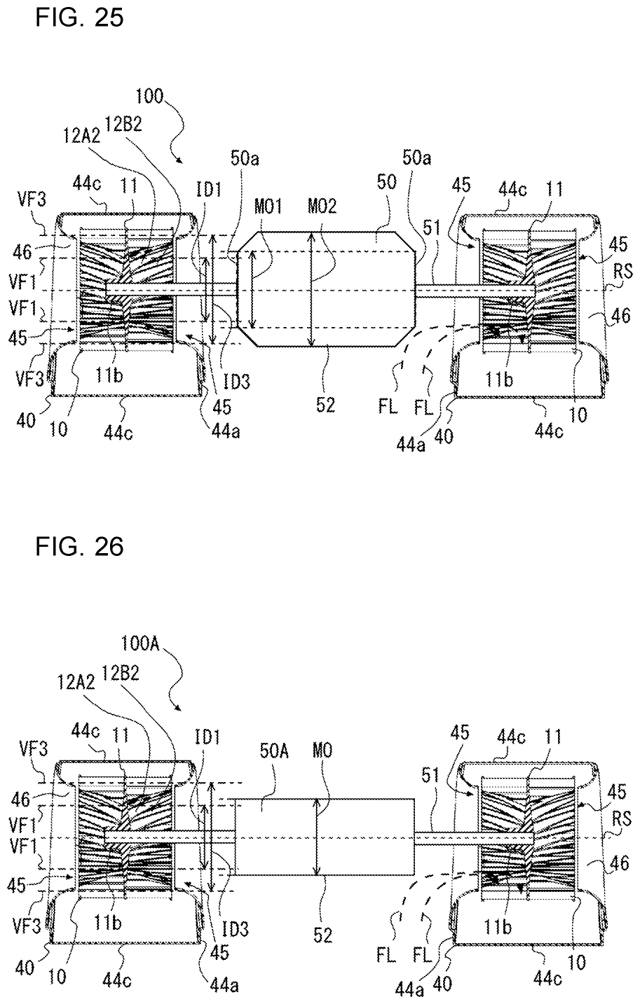

FIG. 25 is a conceptual view that illustrates a relationship between the impellers 10 and the motor 50 included in a centrifugal air-sending device 100 according to Embodiment 5. Dotted lines FL illustrate an example of airflows that pass from the outside of the scroll casings 40 into the insides of the scroll casings 40. As illustrated in FIG. 25, the centrifugal air-sending device 100 may also have, in addition to the impellers 10 and the scroll casings 40, the motor 50, which is configured to rotate the main plates 11 of the respective impellers 10. In other words, the centrifugal air-sending device 100 may also have the impellers 10, the scroll casings 40, which house the respective impellers 10, and the motor 50, which is configured to rotate the impellers 10.

The motor 50 is located next to the side walls 44a of the respective scroll casings 40. The motor shaft 51 is connected to the main plates 11 and serves as the rotation axis of the main plates 11. The motor shaft 51 of the motor 50 extends on the rotation axis RS of the impellers 10, passes through side faces of the scroll casings 40, and is inserted into the scroll casings 40.

The main plates 11 are each located along one of the side walls 44a of the respective the scroll casings 40 that is closest to the motor 50 and located perpendicular to the rotation axis RS. The boss portion 11b, to which the motor shaft 51 is connected, is located at the center portion of each of the main plates 11. The motor shaft 51, which is inserted into the scroll casings 40, is fixed at the boss portions 11b of the main plates 11. The motor shaft 51 of the motor 50 is connected to and fixed at the main plates 11 of the respective impellers 10.

As illustrated in FIG. 25, an outer circumferential wall 52 of the motor 50 is located between an extension surface VF1 and an extension surface VF3. The extension surface VF1 is a virtual surface that extends from the blade inner diameter of the blades 12 close to the corresponding one of the main plates 11 in the axial direction of the rotation axis RS. The extension surface VF3 is a virtual surface that extends from the blade inner diameter close to the corresponding one of the side plates 13 in the axial direction of the rotation axis RS. The outer circumferential wall 52 of the motor 50 defines an outer diameter MO1 of end portions 50a of the motor 50. A portion of the outer circumferential wall 52, which defines the outer diameter MO1 of the end portions 50a of the motor 50, is located such that the portion of the outer circumferential wall 52 faces the first turbo vane portions 12A2 and the second turbo vane portions 12B2 in the axial direction of the rotation axis RS. More specifically, the outer diameter MO1 of the end portions 50a of the motor 50 is larger than the inner diameter ID1 of the plurality of first blades 12A close to the corresponding one of the main plates 11 and smaller than the inner diameter ID3 of the plurality of first blades 12A close to the corresponding one of the side plates 13. In other words, the outer diameter MO1 of the end portions 50a of the motor 50 is larger than the blade inner diameter of the plurality of blades 12 close to the corresponding one of the main plates 11 and is smaller than the blade inner diameter of the plurality of blades 12 close to the corresponding one of the side plates 13. When the portion of the outer circumferential wall 52 at the end portions 50a of the motor 50 is viewed parallel to the rotation axis RS, the portion of the outer circumferential wall 52 is located between the circle Cia and the circle C7a described above (refer to FIG. 14 and FIG. 15) and in the regions of the first turbo vane portions 12A2 and the second turbo vane portions 12B2. As for the dimension of the outer diameter MO2 of the motor 50 other than the dimension at the end portions 50a in the centrifugal air-sending device 100, the size of the outer diameter MO2 is not limited.

FIG. 26 is a conceptual view that illustrates a centrifugal air-sending device 100A that is a modification 1 of the centrifugal air-sending device 100 according to Embodiment 5. The centrifugal air-sending device 100A is formed such that the outer circumferential wall 52 of a motor 50A is located between the extension surface VF1 and the extension surface VF3. The extension surface VF1 is a virtual surface that extends from the blade inner diameter of the blades 12 close to the corresponding one of the main plates 11 in the axial direction of the rotation axis RS. The extension surface VF3 is a virtual surface that extends from the blade inner diameter close to the corresponding one of the side plates 13 in the axial direction of the rotation axis RS. The outer circumferential wall 52 of the motor 50A defines an outer diameter MO of the motor 50A. The outer circumferential wall 52, which defines the outer diameter MO of the motor 50A, is located such that the outer circumferential wall 52 faces the first turbo vane portions 12A2 and the second turbo vane portions 12B2 in the axial direction of the rotation axis RS. More specifically, the outer diameter MO of the motor 50A is larger than the inner diameter ID1 of the plurality of first blades 12A close to the corresponding one of the main plates 11 and smaller than the inner diameter ID3 of the plurality of first blades 12A close to the corresponding one of the side plates 13. In other words, the outer diameter MO of the motor 50A is larger than the blade inner diameter of the plurality of blades 12 close to the corresponding one of the main plates 11 and is smaller than the blade inner diameter of the plurality of blades 12 close to the corresponding one of the side plates 13. When the outer circumferential wall 52 of the motor 50A is viewed parallel to the rotation axis RS, the outer circumferential wall 52 of the motor 50A is located between the circle Cia and the circle C7a described above (refer to FIG. 14 and FIG. 15) and in the regions of the first turbo vane portions 12A2 and the second turbo vane portions 12B2.

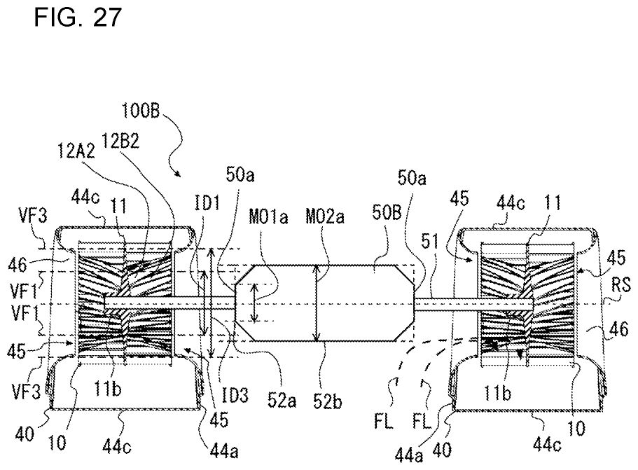

FIG. 27 is a conceptual view that illustrates a centrifugal air-sending device 100B that is a modification 2 of the centrifugal air-sending device 100 according to Embodiment 5. As illustrated in FIG. 27, a portion of an outer circumferential wall 52a, which defines an outer diameter MO1a of the end portions 50a of the motor 50B, is located between the rotation axis RS and the extension surface VF1, which is a virtual surface that extends from the blade inner diameter close to the corresponding one of the side plates 13 in the axial direction of the rotation axis RS. The outer circumferential walls 52a, which each define the outer diameter MO1a of the end portions 50a of the motor 50B, are each located such that the outer circumferential wall 52a faces the first turbo vane portions 12A2 and the second turbo vane portions 12B2 in the axial direction of the rotation axis RS. More specifically, the outer diameter MO1a of the end portions 50a of the motor 50B is smaller than the inner diameter ID1 of the plurality of first blades 12A close to the corresponding one of the main plates 11. In other words, the outer diameter MO1a of the end portions 50a of the motor 50B is formed such that the outer diameter MO1a is smaller than the blade inner diameter of the plurality of blades 12 close to the corresponding one of the main plates 11. When the outer circumferential walls 52a at the end portions 50a of the motor 50B are viewed parallel to the rotation axis RS, the outer circumferential walls 52a at the end portions 50a of the motor 50B is located in the circle Cia described above.

The centrifugal air-sending device 100B is formed such that the outer circumferential wall 52b of the motor 50B is located between the extension surface VF1 and the extension surface VF3. The extension surface VF1 is a virtual surface that extends from the blade inner diameter of the blades 12 close to the corresponding one of the main plates 11 in the axial direction of the rotation axis RS. The extension surface VF3 is a virtual surface that extends from the blade inner diameter close to the corresponding one of the side plates 13 in the axial direction of the rotation axis RS. The outer circumferential wall 52b of the motor 50B defines an outermost diameter MO2a of the motor 50B. The outer circumferential wall 52b, which defines the outermost diameter MO2a of the motor 50B, is also located such that the outer circumferential wall 52b faces the first turbo vane portions 12A2 and the second turbo vane portions 12B2 in the axial direction of the rotation axis RS. More specifically, the outermost diameter MO2a of the motor 50B is larger than the inner diameter ID1 of the plurality of first blades 12A close to the corresponding one of the main plates 11 and smaller than the inner diameter ID3 of the plurality of first blades 12A close to the corresponding one of the side plates 13. In other words, the outermost diameter MO2a of the motor 50B is larger than the blade inner diameter of the plurality of blades 12 close to the corresponding one of the main plates 11 and is smaller than the blade inner diameter of the plurality of blades 12 close to the corresponding one of the side plates 13. When the outer circumferential wall 52b of the motor 50B, which defines the outermost diameter MO2a, is viewed parallel to the rotation axis RS, the outer circumferential wall 52b of the motor 50B is located between the circle Cia and the circle C7a described above (refer to FIG. 14 and FIG. 15) and in the regions of the first turbo vane portions 12A2 and the second turbo vane portions 12B2.

[Advantageous Effects of Impeller 10 and Centrifugal Air-Sending Device 100]

In the impellers 10 and the centrifugal air-sending device 100, the proportion for which the turbo vane portion accounts is higher in the radial direction than the proportion for which the sirocco vane portion accounts in the first region and the second region of the impellers 10. The impellers 10 and the centrifugal air-sending device 100, in which the proportion for which the turbo vane portion accounts is high in any of regions between the main plates 11 and the side plates 13, are configured to sufficiently recover pressure by the plurality of blades 12. The impellers 10 and the centrifugal air-sending device 100 are thus configured to further recover pressure than an impeller and a centrifugal air-sending device that do not have the configuration described above. As a result, the impeller 10 is configured to improve efficiency of the centrifugal air-sending device 100. The impeller 10, which has the configuration described above, is further configured to reduce leading edge separation at the side plates 13.

The plurality of blades 12 also each have a radial vane portion, which connects between the corresponding one of the turbo vane portions and the corresponding one of the sirocco vane portions. The radial vane portions each have a vane angle that is formed at 90 degrees. In a case in which the impeller 10 is provided with a radial vane portion between a turbo vane portion and a sirocco vane portion, no acute change is made in angle of a connection portion at which the turbo vane portion and the sirocco vane portion is connected to each other. The impeller 10 is thus configured to reduce change in pressure in the scroll casing 40, increase fan efficiency of the centrifugal air-sending device 100, and further reduce noise.

At least one second blade 12B of the plurality of second blades 12B is also located between two of the plurality of first blades 12A that are next to each other in the circumferential direction. Even in the second blades 12B, the impeller 10 and the centrifugal air-sending device 100, in which the proportion for which the turbo vane portion accounts is high in any of regions between the main plate 11 and the side plates 13, are configured to sufficiently recover pressure by the plurality of second blades 12B. The impeller 10 and the centrifugal air-sending device 100 are thus configured to further recover pressure than an impeller and a centrifugal air-sending device that do not have the configuration described above. As a result, the impeller 10 is configured to improve efficiency of the centrifugal air-sending device 100. The impeller 10, which has the configuration described above, is further configured to reduce leading edge separation of an airflow at the side plates 13.

The plurality of second blades 12B are also formed such that a ratio of the inner diameter of the respective inner circumferential ends 14B of the plurality of second blades 12B to the outer diameter of the respective outer circumferential ends 15B of the plurality of second blades 12B is lower than or equal to 0.7. Even in the second blades 12B, the impeller 10 and the centrifugal air-sending device 100, in which the proportion for which the turbo vane portion accounts is high in any of regions between the main plate 11 and the side plates 13, are configured to sufficiently recover pressure by the second blades 12B. The impeller 10 and the centrifugal air-sending device 100 are thus configured to further recover pressure than an impeller and a centrifugal air-sending device that do not have the configuration described above. As a result, the impeller 10 is configured to improve efficiency of the centrifugal air-sending device 100. The impeller 10, which has the configuration described above, is further configured to reduce leading edge separation of an airflow at the side plates 13.

The plurality of blades 12 also has a proportion for which the region of the turbo vane portions accounts that is higher in radial directions of the main plate 11 than a proportion for which the region of the sirocco vane portions accounts at portions of the plurality of blades 12 outside the inner diameter BI of the bell mouth 46 in the radial directions from the rotation axis RS. In a case in which the configuration described above is located in any of regions between the main plate 11 and the corresponding one of the side plates 13, the specification of the plurality of blades 12 is satisfied. The plurality of blades 12, which have the configuration described above, are configured to increase the amount of air sucked in portions of the blades 12 that are inside the inner diameter BI of the bell mouth 46. The plurality of blades 12, which have the increased proportion for which the turbo vane portions account at portions of the plurality of blades 12 that are outside the inner diameter BI of the bell mouth 46, are also configured to increase the amount of air discharged from the impeller 10. The plurality of blades 12, which have the configuration described above, are further configured to increase pressure recovery in the scroll casing 40 and thus increase fan efficiency.

In addition, the inner diameter BI of the bell mouth 46 is larger than the blade inner diameter of the plurality of blades 12 that is at the main plate 11 and smaller than the blade inner diameter of the plurality of blades 12 that is at the corresponding one of the side plates 13. The centrifugal air-sending device 100 is thus configured to reduce interference between a suction airflow that passes in from the casing suction ports 45 of the bell mouths 46 and portions of the blades 12 close to the corresponding one of the side plates 13 and further reduce noise.

The inner diameter BI of the bell mouth 46 is also larger than the blade inner diameter of the plurality of second blades 12B that is at the main plate 11 and smaller than the blade inner diameter of the plurality of second blades 12B that is at the corresponding one of the side plates 13. The centrifugal air-sending device 100 is thus configured to reduce interference between a suction airflow that passes in from the casing suction ports 45 of the bell mouths 46 and portions of the second blades 12B close to the corresponding one of the side plates 13 and further reduce noise.

In addition, the distance MS, which is the closest-approach distance between which the plurality of blades 12 are closest to the circumferential wall 44c, is larger than twice the radial length of the sirocco vane portions. The centrifugal air-sending device 100 is thus configured to recover pressure at the turbo vane portions and has a distance between the scroll casing 40 and the impeller 10 at the closest-approach position at which the scroll casing 40 and the impeller 10 are closest to each other and thus reduce noise.

In addition, in the centrifugal air-sending device 100, the outer diameter MO1 of the end portions 50a of the motor 50 is larger than the blade inner diameter of the plurality of blades 12 at the corresponding one of the main plates 11 and is smaller than the blade inner diameter of the plurality of blades 12 at the corresponding one of the side plates 13. The centrifugal air-sending device 100, which has the configuration described above and in which an airflow around the motor 50 is caused to turn toward the impellers 10 in the axial direction of the rotation axis RS of the impellers 10 and smoothly flow into the scroll casings 40, is configured to increase an airflow discharged from the impellers 10. The centrifugal air-sending device 100, which has the configuration described above, is configured to increase pressure recovery in the scroll casings 40 and thus increase fan efficiency.

In the centrifugal air-sending device 100A, the outer diameter MO of the motor 50A is larger than the blade inner diameter of the plurality of blades 12 at the corresponding one of the main plates 11 and is smaller than the blade inner diameter of the plurality of blades 12 at the corresponding one of the side plates 13. The centrifugal air-sending device 100A, which has the configuration described above and in which an airflow around the motor 50A is caused to turn toward the impellers 10 in the axial direction of the rotation axis RS of the impellers 10 and smoothly flow into the scroll casings 40, is configured to increase the amount of air discharged from the impellers 10. The centrifugal air-sending device 100A, which has the configuration described above, is also configured to increase pressure recovery in the scroll casings 40 and thus increase fan efficiency.

In the centrifugal air-sending device 100B, the outermost diameter MO2a of the motor 50B is larger than the blade inner diameter of the plurality of blades 12 at the corresponding one of the main plates 11 and is smaller than the blade inner diameter of the plurality of blades 12 at the corresponding one of the side plates 13. In addition, the centrifugal air-sending device 100B is also formed such that the outer diameter MO1a of the end portions 50a of the motor 50B is smaller than the blade inner diameter of the plurality of blades 12 at the corresponding one of the main plates 11. The centrifugal air-sending device 100B, which has the configuration described, is configured to cause air to smoothly flow into the scroll casings 40 and increase the amount of air discharged from the impellers 10 in comparison with the centrifugal air-sending device 100A and other device. In addition, the centrifugal air-sending device 100B, which has the configuration described above, is configured to further increase pressure recovery in the scroll casings 40 and thus increase fan efficiency in comparison with the centrifugal air-sending device 100A and other device.

### Embodiment 6

[Centrifugal Air-Sending Device 100C]

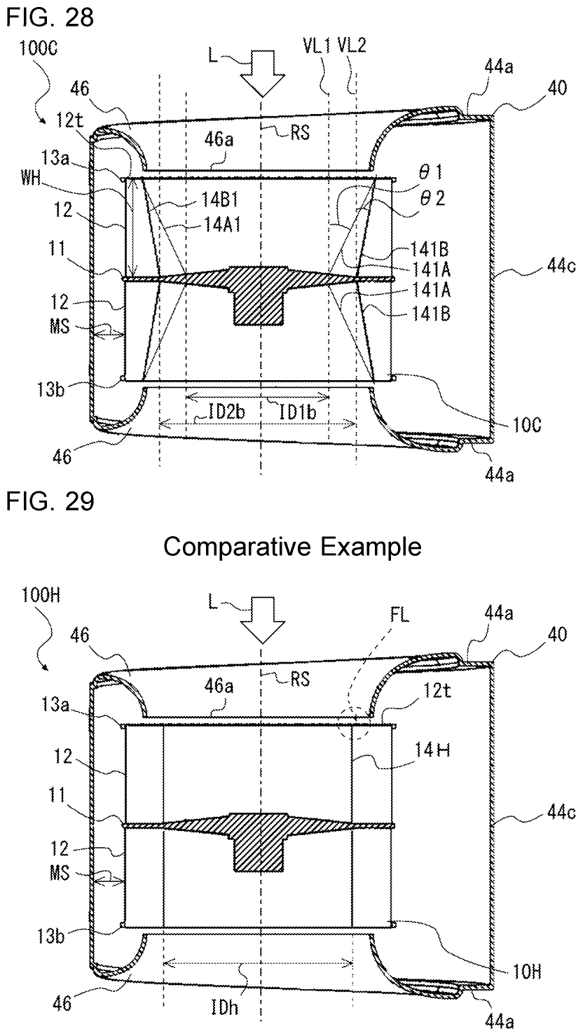

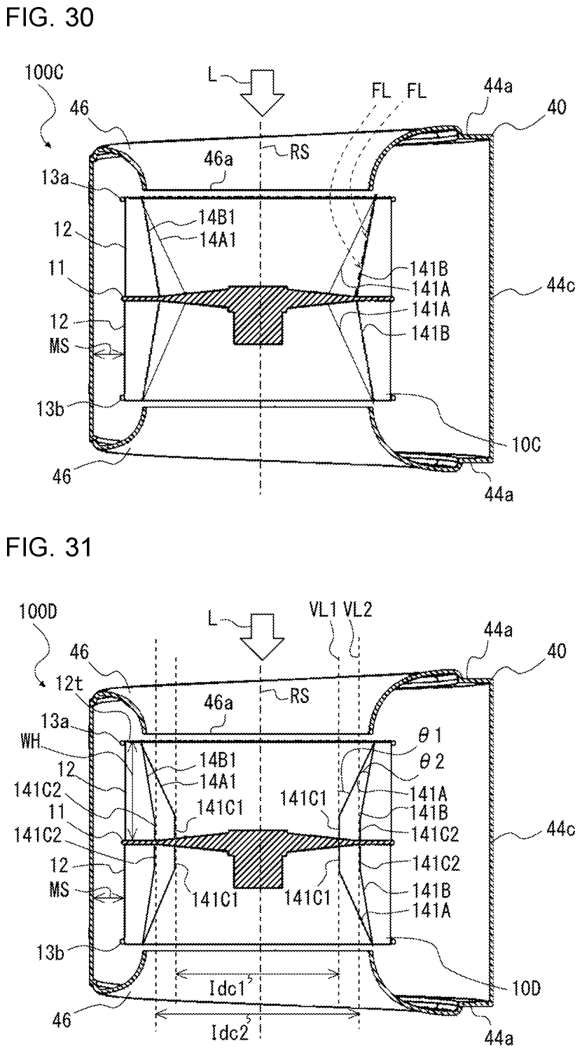

FIG. 28 is a sectional view that schematically illustrates a centrifugal air-sending device 100C according to Embodiment 6. FIG. 29 is a sectional view that schematically illustrates a centrifugal air-sending device 100H according to a comparative example. FIG. 30 is a sectional view that schematically illustrates an operation of the centrifugal air-sending device 100C according to Embodiment 6. FIG. 28 is a sectional view that schematically illustrates an effect of the centrifugal air-sending device 100C according to Embodiment 6. The centrifugal air-sending device 100C according to Embodiment 6 is described below with reference to FIG. 28 and FIG. 30. Components that are the same in configuration as those of the centrifugal air-sending device 100 or other devices illustrated in FIG. 1 to FIG. 27 are given the same reference signs and description of such components is omitted. An impeller 10C of the centrifugal air-sending device 100C according to Embodiment 6 is to be further specified in configuration of the inclination portions 141A and the inclination portions 141B of the plurality of blades 12 included in the centrifugal air-sending device 100 and the impeller 10 according to Embodiment 1. The impeller 10C is thus described below mainly on the configuration of the inclination portions 141A and the inclination portions 141B in the centrifugal air-sending device 100C according to Embodiment 6 with reference to FIG. 28 to FIG. 30.

As describe above, the plurality of blades 12 have the inclination portions 141A, in which the leading edges 14A1 are inclined away from the rotation axis RS such that the blade inner diameter is increased from the main plate 11 toward the corresponding one of the side plates 13. In other words, the plurality of blades 12 have the inclination portions 141A, in which the inner circumferential ends 14A are inclined away from the rotation axis RS such that the blade inner diameter is increased from the main plate 11 toward the corresponding one of the side plates 13. Similarly, the plurality of blades 12 have the inclination portions 141B, in which the leading edges 14B1 are inclined away from the rotation axis RS such that the blade inner diameter is increased from the main plate 11 toward the corresponding one of the side plates 13. In other words, the plurality of blades 12 have the inclination portions 141B, in which the inner circumferential ends 14B are inclined away from the rotation axis RS such that the blade inner diameter is increased from the main plate 11 toward the corresponding one of the side plates 13. The plurality of blades 12 have slopes made by the inclination portions 141A and the inclination portions 141B at the inner circumference.

The inclination portions 141A are each inclined to the rotation axis RS. The inclination angle of the inclination portion 141A is preferably larger than 0 degrees and smaller than or equal to 60 degrees and is more preferably larger than 0 degrees and smaller than or equal to 45 degrees. In other words, an inclination angle θ1 between the inclination portion 141A and the rotation axis RS preferably satisfies a relationship of 0 degrees<81 s 60 degrees and more preferably satisfies a relationship of 0 degrees<81 s 45 degrees. A virtual line VI1 illustrated in FIG. 28 is a virtual line parallel to the rotation axis RS. An angle between the inclination portion 141A and the virtual line VL1 is thus equal to an angle between the inclination portion 141A and the rotation axis RS.

Similarly, the inclination portions 141B are each inclined to the rotation axis RS. The inclination angle of the inclination portion 141B is preferably larger than 0 degrees and smaller than or equal to 60 degrees and is more preferably larger than 0 degrees and smaller than or equal to 45 degrees. In other words, an inclination angle θ2 between the inclination portion 141B and the rotation axis RS preferably satisfies a relationship of 0 degrees<02 s 60 degrees and more preferably satisfies a relationship of 0 degrees<02 s 45 degrees. A virtual line VL2 illustrated in FIG. 28 is a virtual line parallel to the rotation axis RS. An angle between the inclination portion 141B and the virtual line VL2 is thus equal to an angle between the inclination portion 141B and the rotation axis RS. The inclination angle θ1 and the inclination angle θ2 may also be the same angle or different angles.

A blade height WH illustrated in FIG. 28 is smaller than or equal to 200 mm. The blade height WH is a distance between the main plate 11 and end portions 12t of the plurality of blades 12 in the axial direction of the rotation axis RS and is also the maximum possible distance between the main plate 11 and the end portions 12t of the plurality of blades 12 in the axial direction of the rotation axis RS. The blade height WH is not limited to be smaller than or equal to 200 mm and may also be larger than 200 mm.

[Advantageous Effects of Impeller 10C and Centrifugal Air-Sending Device 100C]

As illustrated in FIG. 29, the centrifugal air-sending device 100H, which is a comparative example, has a constant length in an inner diameter IDh of the leading edges 14H in the axial direction of the rotation axis RS. In other words, the centrifugal air-sending device 100H, which is a comparative example, does not have the inclination portions 141A and the inclination portions 141B and does not have slopes of the blade inner diameters. As illustrated in FIG. 29, in the centrifugal air-sending device 100H, which is a comparative example, air (dotted line FL) thus easily passes the end portions 12t of the impeller 10H or a coiner portion formed between the end portions 12t and the leading edges 14H. The end portions 12t of the impeller 10H or the corner portion formed between the end portions 12t and the leading edges 14H are each a portion in which an area of the blades 12 is small. Air thus passes through such a small gap between the blades 12 next to each other and the centrifugal air-sending device 100H thus faces increased airflow resistance at a time when the air is sucked.

On the other hand, as illustrated in FIG. 30, the centrifugal air-sending device 100C has the inclination portions 141A and the inclination portions 141B and has slopes of the blade inner diameters. As illustrated in FIG. 30, the centrifugal air-sending device 100C, which has the slopes of the blade inner diameters, thus has an increased area of the leading edges of the blades 12 against an airflow and thus faces reduced airflow resistance at a time when air passes through the impeller 10C. As a result, the centrifugal air-sending device 100C is configured to improve air-sending efficiency.

The inclination angle of the inclination portion 141A and the inclination angle of the inclination portion 141B of the centrifugal air-sending device 100C are each set to any angle. When the inclination angle of the inclination portion 141A and the inclination angle of the inclination portion 141B are each increased, the centrifugal air-sending device 100C has more increased area of the leading edges of the blades 12 against airflow. In the centrifugal air-sending device 1000, in a case in which the inclination angle is to be increased in a state in which the predetermined blade height WH is ensured, the impeller 10C and the centrifugal air-sending device 100C have to be increased in size in the radial directions. In a case in which the area of the leading edges of the blades 12 described above is to be increased in a state in which the impeller 10C and the centrifugal air-sending device 100C are prevented from being increased in size, the inclination angle of the inclination portion 141A and the inclination angle of the inclination portion 141B are each preferably set to be smaller than or equal to 60 degrees. In a case in which the impeller 10C and the centrifugal air-sending device 100C are each further reduced in size, the inclination angle of the inclination portion 141A and the inclination angle of the inclination portion 141B are each preferably set to be smaller than or equal to 45 degrees.

[Centrifugal Air-Sending Device 100D]

FIG. 31 is a sectional view that illustrates a centrifugal air-sending device 100D, which is a first modification of the centrifugal air-sending device 100C according to Embodiment 6. The centrifugal air-sending device 100D, which is the first modification of the centrifugal air-sending device 100C according to Embodiment 6, is described below with reference to FIG. 31. Components that are the same in configuration as those of the centrifugal air-sending device 100 or other devices illustrated in FIG. 1 to FIG. 30 are given the same reference signs and description of such components is omitted. The impeller 10D of the centrifugal air-sending device 100D is to be further specified in configuration of the leading edges 14A1 and the leading edges 14B1 of the plurality of blades 12 in the impeller 10C of the centrifugal air-sending device 1000 according to Embodiment 6. The impeller 10D is thus described below mainly on the leading edges 14A1 and the leading edges 14B1 of the centrifugal air-sending device 100D with reference to FIG. 31.

As describe above, the plurality of blades 12 have the inclination portions 141A, in which the leading edges 14A1 are inclined away from the rotation axis RS such that the blade inner diameter is increased from the main plate 11 toward the corresponding one of the side plates 13. Similarly, the plurality of blades 12 have the inclination portions 141B, in which the leading edges 14B1 are inclined away from the rotation axis RS such that the blade inner diameter is increased from the main plate 11 toward the corresponding one of the side plates 13. The plurality of blades 12 have slopes made by the inclination portions 141A and the inclination portions 141B at the inner circumference.

The inclination portion 141A is inclined to the rotation axis RS. The inclination angle of the inclination portion 141A is preferably larger than 0 degrees and smaller than or equal to 60 degrees and is more preferably larger than 0 degrees and smaller than or equal to 45 degrees. In other words, the inclination angle E1 between the inclination portion 141A and the rotation axis RS preferably satisfies a relationship of 0 degrees<61 s 60 degrees and more preferably satisfies a relationship of 0 degrees<1 s 45 degrees. Similarly, the inclination portion 141B is inclined to the rotation axis RS. The inclination angle of the inclination portion 141B is preferably larger than 0 degrees and smaller than or equal to 60 degrees and is more preferably larger than 0 degrees and smaller than or equal to 45 degrees. In other words, the inclination angle θ2 between the inclination portion 141B and the rotation axis RS preferably satisfies a relationship of 0 degrees<θ2≤60 degrees and more preferably satisfies a relationship of 0 degrees<θ2≤45 degrees.

The blade height WH illustrated in FIG. 31 is smaller than or equal to 200 mm. The blade height WH is a distance between the main plate 11 and the end portions 12t of the plurality of blades 12 in the axial direction of the rotation axis RS and is also the maximum possible distance between the main plate 11 and the end portions 12t of the plurality of blades 12 in the axial direction of the rotation axis RS. The blade height WH is not limited to be smaller than or equal to 200 mm and may also be larger than 200 mm.

The plurality of blades 12 has a linear portion 141C1 at each of the leading edges 14A1 between the main plate 11 and the corresponding one of the side plates 13. The linear portions 141C1 are each located between the main plate 11 and the corresponding one of the side plates 13 and closer to the main plate 11 than the side plate 13. The leading edge 14A1 of the first blade 12A is thus formed by the linear portion 141C1 and the inclination portion 141A. The linear portion 141C1 is located closer to the main plate 11 than is the inclination portion 141A, which is closer to the corresponding one of the side plates 13 than is the linear portion 141C1. The impeller 10D of the centrifugal air-sending device 100D has an inner diameter IDc1 of the linear portions 141C1 of the leading edges 14A1. The inner diameter IDc1 has a constant length in the axial direction of the rotation axis RS.

Similarly, the plurality of blades 12 has a linear portion 141C2 at each of the leading edges 14B1 between the main plate 11 and the corresponding one of the side plates 13. The linear portions 141C2 are each located between the main plate 11 and the corresponding one of the side plates 13 and closer to the main plate 11 than the side plate 13. The leading edge 14B1 of the second blade 12B is thus formed by the linear portion 141C2 and the inclination portion 141B. The linear portion 141C2 is located closer to the main plate 11 than is the inclination portion 141B, which is closer to the corresponding one of the side plates 13 than is the linear portion 141C2. The impeller 10D of the centrifugal air-sending device 100D has an inner diameter IDc2 of the linear portions 141C2 of the leading edges 14B1. The inner diameter IDc2 has a constant length in the axial direction of the rotation axis RS.

[Advantageous Effects of Impeller 10D and Centrifugal Air-Sending Device 100D]

As illustrated in FIG. 31, the centrifugal air-sending device 100D has the inclination portions 141A and the inclination portions 141B at the leading edges of the blades 12 and has slopes of the blade inner diameters. The centrifugal air-sending device 100D, which has the slopes of the blade inner diameters, thus has an increased area of the leading edges of the blades 12 against an airflow and thus faces reduced airflow resistance at a time when air passes through the impeller 10D. As a result, the centrifugal air-sending device 100D is configured to improve air-sending efficiency.

[Centrifugal Air-Sending Device 100E]

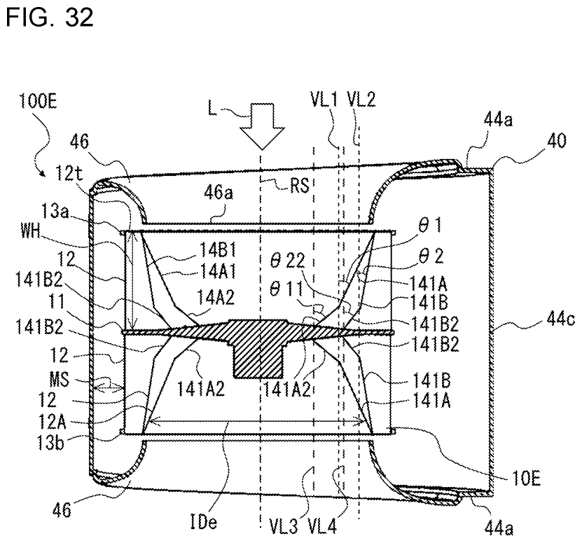

FIG. 32 is a sectional view that illustrates a centrifugal air-sending device 100E, which is a second modification of the centrifugal air-sending device 100C according to Embodiment 6. The centrifugal air-sending device 100E, which is the second modification of the centrifugal air-sending device 100C according to Embodiment 6, is described below with reference to FIG. 32. Components that are the same in configuration as those of the centrifugal air-sending device 100 or other devices illustrated in FIG. 1 to FIG. 31 are given the same reference signs and description of such components is omitted. The impeller 10E of the centrifugal air-sending device 100E is to be further specified in configuration of the leading edges 14A1 and the leading edges 14B1 of the plurality of blades 12 in the impeller 10C of the centrifugal air-sending device 100C according to Embodiment 6. The impeller 10E is thus described below mainly on the leading edges 14A1 and the leading edges 14B1 of the centrifugal air-sending device 100E with reference to FIG. 32.

As describe above, the plurality of blades 12 have the inclination portions 141A, in which the leading edges 14A1 are inclined away from the rotation axis RS such that a blade inner diameter IDe is increased from the main plate 11 toward the corresponding one of the side plates 13. The plurality of blades 12 also have inclination portions 141A2, in which the leading edges 14A1 are inclined away from the rotation axis RS such that the blade inner diameter IDe is increased from the main plate 11 toward the corresponding one of the side plates 13. The linear portions 141A2 are each located between the main plate 11 and the corresponding one of the side plates 13 and closer to the main plate 11 than the side plate 13. The leading edge 14A1 of the first blade 12A is thus formed by the inclination portion 141A2 and the inclination portion 141A. The inclination portion 141A2 is located closerto the main plate 11 than is the inclination portion 141A, which is closer to the corresponding one of the side plates 13 than is the inclination portion 141A2. In other words, the first blades 12A of the plurality of blades 12 each have two inclination portions, which are the inclination portion 141A and the inclination portion 141A2, located between the main plate 11 and the corresponding one of the side plates 13. The first blades 12A of the plurality of blades 12 are not limited to each have two inclination portions, which are the inclination portion 141A and the inclination portion 141A2, and are only required to each have two or more inclination portions.

Similarly, the plurality of blades 12 have the inclination portions 141B, in which the leading edges 14B1 are inclined away from the rotation axis RS such that the blade inner diameter IDe is increased from the main plate 11 toward the corresponding one of the side plates 13. The plurality of blades 12 also have inclination portions 141B2, in which the leading edges 14B1 are inclined away from the rotation axis RS such that the blade inner diameter IDe is increased from the main plate 11 toward the corresponding one of the side plates 13. The linear portions 141B2 are each located between the main plate 11 and the corresponding one of the side plates 13 and closer to the main plate 11 than the side plate 13. The leading edge 141B1 of the second blade 12B is thus formed by the inclination portion 141B2 and the inclination portion 141B. The inclination portion 141B2 is located closer to the main plate 11 than is the inclination portion 141B, which is closer to the corresponding one of the side plates 13 than is the inclination portion 141B2. In other words, the second blades 12B of the plurality of blades 12 each have two inclination portions, which are the inclination portion 141B and the inclination portion 141B2, located between the main plate 11 and the corresponding one of the side plates 13. The second blades 12B of the plurality of blades 12 are not limited to each have two inclination portions, which are the inclination portion 141B and the inclination portion 141B2, and are only required to each have two or more inclination portions. The plurality of blades 12 have slopes made by the inclination portions 141A, the inclination portions 141A2, the inclination portions 141B, and the inclination portions 141B2 at the inner circumference.

At least one of the inclination portion 141A and the inclination portion 141A2 is inclined to the rotation axis RS. Either or both the inclination angle of the inclination portion 141A and the inclination angle of the inclination portion 141A2 are each preferably larger than 0 degrees and smaller than or equal to 60 degrees and are each more preferably larger than 0 degrees and smaller than or equal to 45 degrees. In other words, the inclination angle θ1 between the inclination portion 141A and the rotation axis RS preferably satisfies a relationship of 0 degrees<θ1≤60 degrees and more preferably satisfies a relationship of 0 degrees<81 s 45 degrees. Alternatively, an inclination angle θ11 between the inclination portion 141A2 and the rotation axis RS preferably satisfies a relationship of 0 degrees<θ11≤60 degrees and more preferably satisfies a relationship of 0 degrees<θ11≤45 degrees. A virtual line VL3 illustrated in FIG. 32 is a virtual line parallel to the rotation axis RS. An angle between the inclination portion 141A2 and the virtual line VL3 is thus equal to an angle between the inclination portion 141A2 and the rotation axis RS.

The inclination angle θ1 at the inclination portion 141A has degrees that are different from degrees of the inclination angle θ11 at the inclination portion 141A2. In a case in which the first blade 12A has two or more inclination portions, the two or more inclination portions have respective degrees that are different from each other. The relationship between the degrees of the inclination angle θ1 at the inclination portion 141A and the degrees of the inclination angle θ11 at the inclination portion 141A2 is not limited. For example, the first blades 12A may also each have, as illustrated in FIG. 32, the degrees of the inclination angle θ11 at the inclination portion 141A2 that are larger than the degrees of the inclination angle θ1 at the inclination portion 141A. Alternatively, the first blades 12A may also each have the degrees of the inclination angle θ11 at the inclination portion 141A2 that are smaller than the degrees of the inclination angle θ1 at the inclination portion 141A.

Similarly, at least one of the inclination portion 141B and the inclination portion 141B2 is inclined to the rotation axis RS. Either or both the inclination angle of the inclination portion 141B and the inclination angle of the inclination portion 141B2 are each preferably larger than 0 degrees and smaller than or equal to 60 degrees and are each more preferably larger than 0 degrees and smaller than or equal to 45 degrees. In other words, the inclination angle θ2 between the inclination portion 141B and the rotation axis RS preferably satisfies a relationship of 0 degrees<θ2≤60 degrees and more preferably satisfies a relationship of 0 degrees<82 s 45 degrees. Alternatively, an inclination angle θ22 between the inclination portion 141B2 and the rotation axis RS preferably satisfies a relationship of 0 degrees<θ22≤60 degrees and more preferably satisfies a relationship of 0 degrees<θ22≤45 degrees. A virtual line VL4 illustrated in FIG. 32 is a virtual line parallel to the rotation axis RS. An angle between the inclination portion 141B2 and the virtual line VL4 is thus equal to an angle between the inclination portion 141B2 and the rotation axis RS.

The inclination angle θ2 at the inclination portion 141B has degrees that are different from degrees of the inclination angle θ22 at the inclination portion 141B2. In a case in which the second blade 12B has two or more inclination portions, the two or more inclination portions have respective degrees that are different from each other. The relationship between the degrees of the inclination angle θ2 at the inclination portion 141B and the degrees of the inclination angle θ22 at the inclination portion 141B2 is not limited. For example, the second blades 12B may also each have, as illustrated in FIG. 32, the degrees of the inclination angle θ22 at the inclination portion 141B2 that are larger than the degrees of the inclination angle θ2 at the inclination portion 141B. Alternatively, the second blades 12B may also each have the degrees of the inclination angle θ22 at the inclination portion 141B2 that are smaller than the degrees of the inclination angle θ2 at the inclination portion 141B.

The blade height WH illustrated in FIG. 32 is smaller than or equal to 200 mm. The blade height WH is a distance between the main plate 11 and the end portions 12t of the plurality of blades 12 in the axial direction of the rotation axis RS and is also the maximum possible distance between the main plate 11 and the end portions 12t of the plurality of blades 12 in the axial direction of the rotation axis RS. The blade height WH is not limited to be smaller than or equal to 200 mm and may also be larger than 200 mm.

[Advantageous Effects of Impeller 10E and Centrifugal Air-Sending Device 100E]

As illustrated in FIG. 32, the centrifugal air-sending device 100E has the inclination portions 141A, the inclination portions 141A2, the inclination portions 141B, and the inclination portions 141B2 at the leading edges of the blades 12 and has slopes of the blade inner diameters IDe. The centrifugal air-sending device 100E, which has the slopes of the blade inner diameters IDe, thus has an increased area of the leading edges of the blades 12 against an airflow and thus faces reduced airflow resistance at a time when air passes through the impeller 10E. As a result, the centrifugal air-sending device 100E is configured to improve air-sending efficiency.

### Embodiment 7

[Centrifugal Air-Sending Device 100F]

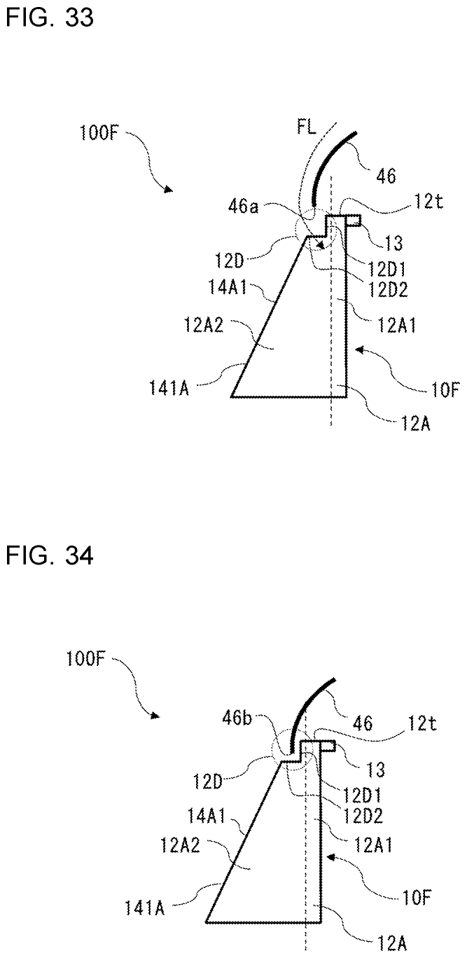

FIG. 33 is a schematic view that illustrates a relationship between the bell mouth 46 and the blade 12 included in a centrifugal air-sending device 100F according to Embodiment 7. FIG. 34 is a schematic view that illustrates a relationship between the bell mouth 46 and the blade 12 included in a centrifugal air-sending device that is a modification of the centrifugal air-sending device 100F according to Embodiment 7. The centrifugal air-sending device 100F according to Embodiment 7 is described below with reference to FIG. 33 and FIG. 34. Components that are the same in configuration as those of the centrifugal air-sending device 100 or other devices illustrated in FIG. 1 to FIG. 32 are given the same reference signs and description of such components is omitted. An impeller 10F of the centrifugal air-sending device 100F according to Embodiment 7 is to be further specified in configuration of the turbo vane portions of the impeller 10 included in the centrifugal air-sending device 100 according to Embodiment 1. The impeller 10F is thus described below mainly on the turbo vane portion of the centrifugal air-sending device 100F according to Embodiment 7 with reference to FIG. 33 and FIG. 34.

The impeller 10F of the centrifugal air-sending device 100F according to Embodiment 7 has a level-difference portion 12D at each of the end portions 12t, which are respective end portions of the turbo vane portions that are located closest to the corresponding one of the side plates 13. As illustrated in FIG. 33, the level-difference portion 12D is described below by use of one of the first blades 12A. The level-difference portion 12D is formed at each of the end portions 12t, which are respective end portions of the first turbo vane portions 12A2 that are located closest to the corresponding one of the side plates 13. In other words, the level-difference portion 12D is formed at each of the end portions 12t, which are respective end portions of the inclination portions 141A that are located closest to the corresponding one of the side plates 13. The level-difference portion 12D is a portion of each of the first blades 12A and formed in a state in which a wall of the first blade 12A is partially cut off. The level-difference portion 12D is a portion of each of the first blades 12A and formed in a state in which a connection portion of the first blade 12A is cut off. The connection portion is a portion at which the leading edge 14A1 of the first blade 12A and the end portion 12t of the first turbo vane portion 12A2, which is closest to the corresponding one of the side plates 13, are connected to each other. The level-difference portion 12D is formed by a side edge portion 12D1 and a top edge portion 12D2. The side edge portion 12D1 extends in the axial direction of the rotation axis RS and the top edge portion 12D2 extends in a radial direction of the impeller 10F. The level-difference portion 12D is, however, not limited to such a configuration in which the level-difference portion 12D is formed by the side edge portion 12D1, which extends in the axial direction of the rotation axis RS of the impeller 10F, and the top edge portion 12D2, which extends in a radial direction of the impeller 10F. The level-difference portion 12D may, for example, also be formed as an arcuate edge portion formed by integrating the side edge portion 12D1 and the top edge portion 12D2 with each other such that the side edge portion 12D1 and the top edge portion 12D2 are connected to each other.

The level-difference portion 12D is also formed at each of the second blades 12B. The level-difference portion 12D of the second blade 12B has the same configuration as the level-difference portion 12D of the first blade 12A and an illustration of the level-difference portion 12D of the second blade 12B is not provided. The level-difference portion 12D is formed at each of the end portions 12t, which are respective end portions of the second turbo vane portions 12B2 that are located closest to the corresponding one of the side plates 13. In other words, the level-difference portion 12D is formed at each of the end portions 12t, which are respective end portions of the inclination portions 141B that are located closest to the corresponding one of the side plates 13. The level-difference portion 12D is a portion of each of the second blades 12B and formed in a state in which a wall of the second blade 12B is partially cut off. The level-difference portion 12D is a portion of each of the second blades 12B and formed in a state in which a connection portion of the second blade 12B is cut off. The connection portion is a portion at which the leading edge 14B1 of the second blade 12B and the end portion 12t of the second turbo vane portion 12B2, which is closest to the corresponding one of the side plates 13, are connected to each other.

The plurality of blades 12 of the centrifugal air-sending device 100F according to Embodiment 7 are formed such that the blade outer diameter of the respective outer circumferential ends of the plurality of blades 12 is larger than the inner diameter BI of the bell mouth 46. As illustrated in FIG. 33 and FIG. 34, in the centrifugal air-sending device 100F, the inner circumferential side end portion 46b of the bell mouth 46 is located above the level-difference portion 12D. In the centrifugal air-sending device 100F, the inner circumferential side end portion 46b of the bell mouth 46 is located such that the inner circumferential side end portion 46b of the bell mouth 46 faces the top edge portion 12D2 of the level-difference portion 12D. The centrifugal air-sending device 100F has a gap such that the inner circumferential side end portion 46b of the bell mouth 46 is spaced away from the side edge portion 12D1 and the top edge portion 12D2.

[Advantageous Effects of Impeller 10F and Centrifugal Air-Sending Device 100F]

The impeller 10F and the centrifugal air-sending device 100F have the level-difference portion 12D at each of the end portions 12t, which are respective end portions of the turbo vane portions that are located closest to the corresponding one of the side plates 13. The impeller 10F and the centrifugal air-sending device 100F have a gap increased by the level-difference portions 12D between the bell mouth 46 and the blades 12. The impeller 10F and the centrifugal air-sending device 100F are configured to reduce increase in speed of an airflow through the gap between the bell mouth 46 and the blades 12 and thus reduce noise generated by the airflow, which passes through the gap between the bell mouth 46 and the blades 12.

The impeller 10F and the centrifugal air-sending device 100F have the bell mouth 46, which is located closer to the impeller 10F with decreased distance to the impeller 10F in comparison with a case in which the blades 12 are not provided with the level-difference portions 12D. The impeller 10F and the centrifugal air-sending device 100F, which has the bell mouth 46, which is located closer to the impeller 10F with decreased distance to the impeller 10F, thus has a gap decreased between the bell mouth 46 and the blades 12. As a result, the impeller 10F and the centrifugal air-sending device 100F are configured to reduce leakage of sucked air, that is, the amount of air that does not passes between the blades 12 in the impeller 10F that are next to each other. The impeller 10F and the centrifugal air-sending device 100F, in which the bell mouth 46 and the side edge portions 12D1 are located, as illustrated in FIG. 34, such that the bell mouth 46 and the side edge portions 12D1 face each other, are configured to further reduce leakage of sucked air in comparison with a case in which the bell mouth 46 and the side edge portions 12D1 do not face each other. In other words, the centrifugal air-sending device 100F, in which the bell mouth 46 is located inside the level-difference portions 12D and above the blades 12 and in the radial directions of the blades 12, is configured to further reduce leakage of sucked air in comparison with a case in which the bell mouth 46 is not located inside the level-difference portions 12D.

### Embodiment 8

[Centrifugal Air-Sending Device 100G]

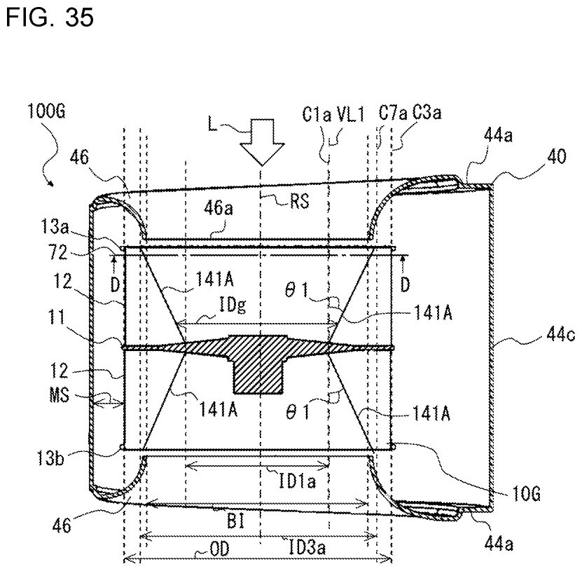

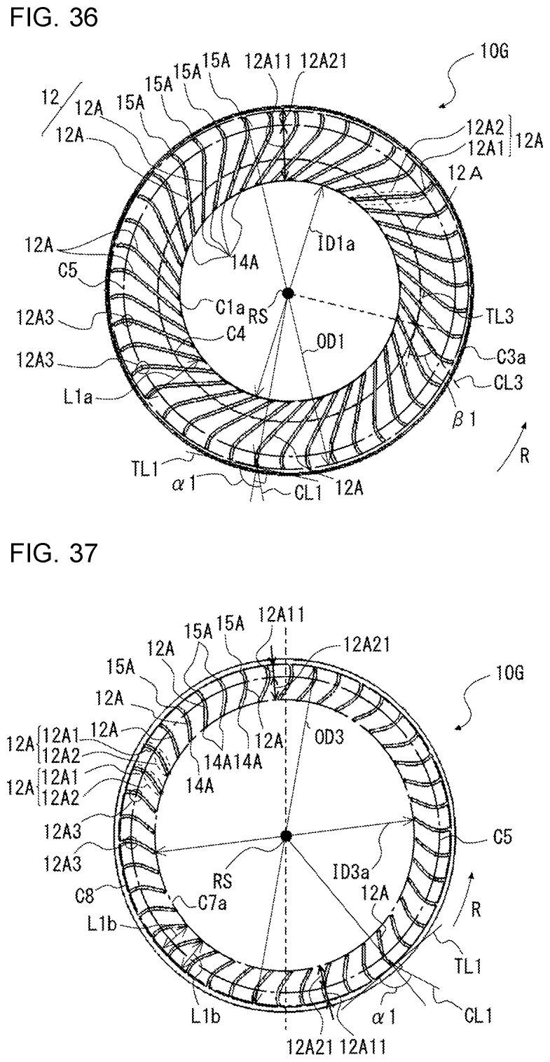

FIG. 35 is a sectional view that schematically illustrates a centrifugal air-sending device 100G according to Embodiment 8. FIG. 36 is a schematic view that illustrates the blades 12 included in an impeller 10G illustrated in FIG. 35 with the blades 12 viewed parallel to the rotation axis RS. FIG. 37 is a schematic view that illustrates the blades 12 included in the impeller 10G illustrated in FIG. 35 with the blades 12 viewed in a section taken along line D-D. The centrifugal air-sending device 100G according to Embodiment 8 is described below with reference to FIG. 35 to FIG. 37. Components that are the same in configuration as those of the centrifugal air-sending device 100 or other devices illustrated in FIG. 1 to FIG. 34 are given the same reference signs and description of such components is omitted.

As illustrated in FIG. 35 to FIG. 37, the impeller 10G of the centrifugal air-sending device 100G according to Embodiment 8 is formed such that all the plurality of blades 12 are each the first blade 12A. As illustrated in FIG. 35 to FIG. 37, the impeller 10G has the 42 first blades 12A. The number of the first blades 12A is, however, not limited to 42 and may also be less than 42 or more than 42.

The first blade 12A has a relationship of vane length L1a>vane length L1b. In other words, the first blade 12A is formed such that the vane length of the first blade 12A decreases from the main plate 11 to the corresponding one of the side plates 13 in the axial direction of the rotation axis RS. As illustrated in FIG. 35, the first blades 12A are inclined such that a blade inner diameter IDg increases from the main plate 11 to the corresponding one of the side plates 13. In other words, the plurality of blades 12 are formed as the inclination portions 141A, in which the inner circumferential ends 14A included in the leading edges 14A1 are inclined away from the rotation axis RS such that the blade inner diameter IDg is increased from the main plate 11 toward the corresponding one of the side plates 13.

The first blades 12A each have the first sirocco vane portion 12A1, which is formed as a forward-curved blade, and a first turbo vane portion 12A2, which is formed as a backward-curved blade. In the first blade 12A, the first turbo region 12A21 is larger than the first sirocco region 12A11 in a radial direction of the impeller 10. In the main-plate-side blade region 122a, which is the first region, and the side-plate-side blade region 122b, which is the second region, in the impeller 10 and the first blades 12A, the proportion for which the first turbo vane portion 12A2 accounts is higher in a radial direction of the impeller 10 than the proportion for which the first sirocco vane portion 12A1 accounts.

When the interval between two blades 12 of the plurality of blades 12 that are next to each other in the circumferential direction is defined as the vane interval, as illustrated in FIG. 36 and FIG. 37, the vane intervals of the plurality of blades 12 each expand from the corresponding one of the leading edges 14A1 toward the corresponding one of the trailing edges 15A1. Specifically, the vane intervals of the first turbo vane portions 12A2 each expand from the inner circumference to the outer circumference. The vane intervals of the first sirocco vane portions 12A1 each are wider than the vane interval of the first turbo vane portions 12A2 and expand from the inner circumference to the outer circumference.

As illustrated in FIG. 35, the inner diameter BI of the bell mouth 46 is larger than the inner diameter IDia of the first blades 12A, which is at the main plate 11, and smaller than the inner diameter ID3a of the first blades 12A, which is at the corresponding one of the side plates 13. In other words, the inner diameter BI of the bell mouth 46 is larger than the blade inner diameter IDg of the plurality of blades 12, which is at the main plate 11, and smaller than the blade inner diameter IDg of the plurality of blades 12, which is at the corresponding one of the side plates 13.

[Advantageous Effects of Impeller 10G and Centrifugal Air-Sending Device 100G]

The impeller 10G and the centrifugal air-sending device 100G are configured to produce the same effects as the centrifugal air-sending device 100 and the impeller 10 according to Embodiment 1. In the impeller 10G and the centrifugal air-sending device 100G, for example, the proportion of the first turbo vane portion 12A2 is higher in a radial direction of the main plate 11 than the proportion of the first sirocco vane portion 12A1 in any of regions between the main plate 11 and the side plates 13. The impeller 10G and the centrifugal air-sending device 100G, in which the proportion for which the turbo vane portion accounts is high in any of regions between the main plate 11 and the side plates 13, are configured to sufficiently recover pressure by the plurality of blades 12. The impeller 10G and the centrifugal air-sending device 100G are thus configured to further recover pressure than an impeller and a centrifugal air-sending device that do not have the configuration described above. As a result, the impeller 10G is configured to improve efficiency of the centrifugal air-sending device 100G. The impeller 10G, which has the configuration described above, is configured to further reduce leading edge separation of an airflow at the side plates 13.

The centrifugal air-sending device 100 according to Embodiment 1 to Embodiment 8 is described as an example, which has the impeller 10, which is a double-suction impeller that has the plurality of blades 12 formed on both faces of the main plate 11. Embodiment 1 to Embodiment 8 may also be applied to the centrifugal air-sending device 100 that has an impeller 10 that is a single-suction impeller that has the plurality of blades 12 formed on one face of the main plate 11.

### Embodiment 9

[Air-Conditioning Apparatus 140]

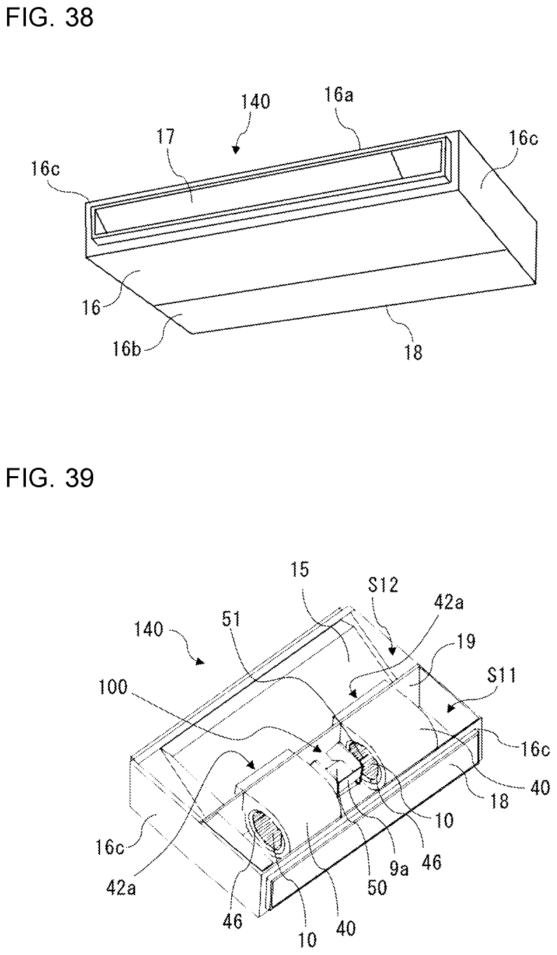

FIG. 38 is a perspective view of an air-conditioning apparatus 140 according to Embodiment 9. FIG. 39 is a perspective view of an internal configuration of the air-conditioning apparatus 140 according to Embodiment 9. For the centrifugal air-sending device 100 used in the air-conditioning apparatus 140 according to Embodiment 9, components that are the same in configuration as those of the centrifugal air-sending device 100 or other devices illustrated in FIG. 1 to FIG. 37 are given the same reference signs and description of such components is omitted. In addition, illustration of a top face portion 16a of the air-conditioning apparatus 140 is not provided in FIG. 39 to illustrate the internal configuration of the air-conditioning apparatus 140.

The air-conditioning apparatus 140 according to Embodiment 9 has any one or more of the centrifugal air-sending device 100 to the centrifugal air-sending device 100G according to Embodiment 1 to Embodiment 8 and a heat exchanger 15, which is positioned at a location at which the heat exchanger 15 faces the discharge port 42a of the centrifugal air-sending device 100. The air-conditioning apparatus 140 according to Embodiment 9 also has a casing 16, which is installed above a ceiling of a target room to be air-conditioned. In the following description, the term “centrifugal air-sending device 100” refers to any one of the centrifugal air-sending devices 100 to the centrifugal air-sending device 100G according to Embodiment 1 to Embodiment 8. In addition, the centrifugal air-sending device 100, which has the scroll casings 40 in the casing 16, is illustrated in FIG. 38 and FIG. 39. Alternatively, the impeller 10 to the impeller 10G or other similar device that is not provided with the scroll casing 40 may also be installed in the casing 16.

Casing 16

As illustrated in FIG. 38, the casing 16 is formed in a cuboidal shape that includes the top face portion 16a, a bottom face portion 16b, and side face portions 16c. The shape of the casing 16 is not limited to the cuboidal shape and may also be another shape such as a circular cylindrical shape, a prismatic shape, a conical shape, a shape that has a plurality of corners, and a shape that has a plurality of curved surfaces. One of the side face portions 16c of the casing 16 is a side face portion 16c in which a casing discharge port 17 is formed. As illustrated in FIG. 38, the casing discharge port 17 is formed in a rectangular shape. The shape of the casing discharge port 17 is not limited to the rectangular shape and may also be another shape such as a circular shape and an oval shape. One of the side face portions 16c of the casing 16 located behind a face in which the casing discharge port 17 is formed is a side face portion 16c in which a casing suction port 18 is formed. As illustrated in FIG. 39, the casing suction port 18 is formed in a rectangular shape. The shape of the casing suction port 18 is not limited to the rectangular shape and may also be another shape such as a circular shape and an oval shape. A filter that removes dust from air may also be provided to the casing suction port 18.

The casing 16 houses the centrifugal air-sending device 100 and the heat exchanger 15. The centrifugal air-sending device 100 has the impellers 10, the scroll casings 40, in which the respective bell mouths 46 are formed, and the motor 50. The motor 50 is supported by a motor support 9a, which is fixed to the top face portion 16a of the casing 16. The motor 50 has the motor shaft 51. The motor shaft 51 is located such that the motor shaft 51 extends parallel to a face of the side face portions 16c in which the casing suction port 18 is formed and parallel to a face of the side face portions 16c in which the casing discharge port 17 is formed. As illustrated in FIG. 39, the air-conditioning apparatus 140 has the two impellers 10, which are attached to the motor shaft 51. The impellers 10 in the centrifugal air-sending device 100 form an airflow that is sucked into the casing 16 through the casing suction port 18 and is blown out through the casing discharge port 17 into a target space to be air-conditioned. The number of the impellers 10 located in the casing 16 is not limited to two and may also be one or three or more.

As illustrated in FIG. 39, the centrifugal air-sending device 100 is attached to a partition plate 19. A space in the casing 16 is divided by the partition plate 19 into a space S11 in which air is sucked into the scroll casings 40 and a space S12 in which air is blown out from the scroll casings 40.

The heat exchanger 15 is positioned at a location at which the heat exchanger 15 faces the discharge ports 42a of the centrifugal air-sending device 100. The heat exchanger 15 is also located in the casing 16 and on an air passage through which air is discharged from the centrifugal air-sending devices 100. The heat exchanger 15 adjusts the temperature of air that is sucked into the casing 16 through the casing suction port 18 and is then blown out through the casing discharge port 17 into the target space to be air-conditioned. To the heat exchanger 15, a heat exchanger that has a publicly-known structure is applicable. The casing suction port 18 is only required to be formed at a location perpendicular to the axial direction of the rotation axis RS of the centrifugal air-sending device 100. For example, the casing suction port 18 may also be formed in the bottom face portion 16b.

When the impellers 10 in the centrifugal air-sending device 100 rotate, air in the target space to be air-conditioned is sucked into the casing 16 through the casing suction port 18. The air sucked into the casing 16 is guided to the bell mouths 46 and sucked into the impellers 10. The air sucked into the impellers 10 is blown out outward in the radial directions of each of the impellers 10. The air blown out from the impellers 10 passes through the insides of the scroll casings 40 first, is blown out from the scroll casings 40 through the discharge ports 42a, and then is supplied to the heat exchanger 15. The air supplied to the heat exchanger 15 has its temperature and humidity adjusted by exchanging heat with refrigerant that flows inside the heat exchanger 15 when the air is passing through the heat exchanger 15. The air that has passed through the heat exchanger 15 is blown out through the casing discharge port 17 into the target space to be air-conditioned.

The air-conditioning apparatus 140 according to Embodiment 9 has any one or more of the centrifugal air-sending device 100 to the centrifugal air-sending device 100G according to Embodiment 1 to Embodiment 8. The air-conditioning apparatus 140 is thus configured to produce the same effects as in any of Embodiment 1 to Embodiment 8.

Ones of Embodiment 1 to Embodiment 9 described above may also be combined with each other and may also be implemented. The configurations of the embodiments described above are merely an example. These configurations may also be combined with other known technique, or may also be partially omitted or changed unless the configurations depart from their scope. For example, in Embodiment 1, the impeller 10, which has the main-plate-side blade region 122a, which is the first region, and the side-plate-side blade region 122b, which is the second region, and other components are described. The impeller 10 is, however, not limited to an impeller that only has the first region and the second region. The impeller 10 may also further has other region in addition to the first region and the second region. For example, in Embodiment 1, the blades are each formed such that the vane length is continuously changed from the main plate 11 to the corresponding one of the side plates 13. The blades may also have a portion that is located between the main plate 11 and the corresponding one of the side plates 13 and at which the vane length is constant, that is, a portion at which the inner diameter ID is constant and is not inclined to the rotation axis RS.

### REFERENCE SIGNS LIST

9a: motor support, 10: impeller, 10C: impeller, 10D: impeller, 10E: impeller, 10F: impeller, 10G: impeller, 10H: impeller, 10L: impeller, 10a: outer circumferential side face, 10e: air inlet, 11: main plate, 11b: boss portion, 11b1: shaft hole, 12: blade, 12A: first blade, 12A1: first sirocco vane portion, 12A11: first sirocco region, 12A2: first turbo vane portion, 12A21: first turbo region, 12A21a: first turbo region, 12A2a: first turbo vane portion, 12A3: first radial vane portion, 12B: second blade, 12B1: second sirocco vane portion, 12B11: second sirocco region, 12B2: second turbo vane portion, 12B21: second turbo region, 12B21a: second turbo region, 12B2a: second turbo vane portion, 12B3: second radial vane portion, 12D: level-difference portion, 12D1: side edge portion, 12D2: top edge portion, 12R: outer circumferential region, 12t: end portion, 13: side plate, 13a: first side plate, 13b: second side plate, 14A: inner circumferential end, 14A1: leading edge, 14B: inner circumferential end, 14B1: leading edge, 14H: leading edge, 15: heat exchanger, 15A: outer circumferential end, 15A1: trailing edge, 15B: outer circumferential end, 15B1: trailing edge, 16: casing, 16a: top face portion, 16b: bottom face portion, 16c: side face portion, 17: casing discharge port, 18: casing suction port, 19: partition plate, 22: blade inner portion, 23: sirocco vane portion, 23a: outer sirocco vane portion, 24: turbo vane portion, 24a: outer turbo vane portion, 25: separation portion, 25a: separation portion, 26: blade outer circumferential portion, 40: scroll casing, 41: scroll portion, 41a: scroll start portion, 41b: scroll end portion, 42: discharge portion, 42a: discharge port, 42b: extension plate, 42c: diffuser plate, 42d: first side plate portion, 42e: second side plate portion, 43: tongue portion, 44a: side wall, 44a1: first side wall, 44a2: second side wall, 44c: circumferential wall, 45: casing suction port, 45a: first suction port, 45b: second suction port, 46: bell mouth, 46a: inner circumferential edge portion, 46b: inner circumferential side end portion, 50: motor, 50A: motor, 50B: motor, 50a: end portion, 51: motor shaft, 52: outer circumferential wall, 52a: outer circumferential wall, 52b: outer circumferential wall, 71: first flat surface, 72: second flat surface, 100: centrifugal air-sending device, 100A: centrifugal air-sending device, 100B: centrifugal air-sending device, 100C: centrifugal air-sending device, 100D: centrifugal air-sending device, 100E: centrifugal air-sending device, 100F: centrifugal air-sending device, 100G: centrifugal air-sending device, 100H: centrifugal air-sending device, 100L: centrifugal air-sending device, 112a: first vane portion, 112b: second vane portion, 122a: main-plate-side blade region, 122b: side-plate-side blade region, 122c: third region, 122d: fourth region, 140: air-conditioning apparatus, 141A: inclination portion, 141A2: inclination portion, 141B: inclination portion, 141B2: inclination portion, 141C1: linear portion, 141C2: linear portion, AR: airflow, BI: inner diameter, BO: outer diameter, C1: circle, C1a: circle, C2: circle, C2a: circle, C3: circle, C3a: circle, C4: circle, C5: circle, C7: circle, C7a: circle, C8: circle, CD: circumferential direction, CL1: center line, CL2: center line, CL3: center line, CL4: center line, E: range, FL: dotted line, ID1: inner diameter, ID1a: inner diameter, ID2: inner diameter, ID2a: inner diameter, ID3: inner diameter, ID3a: inner diameter, ID4: inner diameter, ID4a: inner diameter, IDc1: inner diameter, IDc2: inner diameter, IDe: blade inner diameter, IDg: blade inner diameter, IDh: inner diameter, L: open arrow, L1a: vane length, L1b: vane length, L2a: vane length, L2b: vane length, MO: outer diameter, MO1: outer diameter, MO1a: outer diameter, MO2: outer diameter, MO2a: outermost diameter, MP: intermediate position, MS: distance, OD: blade outer diameter, OD1: outer diameter, OD2: outer diameter, OD3: outer diameter, OD4: outer diameter, R: rotation direction, RS: rotation axis, S11: space, S12: space, SL: distance, TL1: tangent line, TL2: tangent line, TL3: tangent line, TL4: tangent line, VF1: extension surface, VF3: extension surface, VL1: virtual line, VL2: virtual line, VL3: virtual line, VL4: virtual line, W: width dimension, WH: blade height, WS: region, α1: outlet angle, α2: outlet angle, 01: outlet angle, R2: outlet angle, 01: inclination angle, 011: inclination angle, 92: inclination angle, 022: inclination angle

1. A centrifugal air-sending device comprising:
an impeller that has a main plate that is to be driven to rotate, a side plate that is ring-shaped and located such that the side plate faces the main plate, and a plurality of blades that each have one end connected to the main plate and an other end connected to the side plate and are arranged in a circumferential direction centered on a rotation axis of the main plate that is virtual; and
a scroll casing that houses the impeller and has a circumferential wall that is scroll-shaped and a side wall that has a bell mouth that forms a suction port that communicates with a space defined by the main plate and the plurality of blades,
the plurality of blades each having
an inner circumferential end that is closer to the rotation axis than is an outer circumferential end in a radial direction centered on the rotation axis,
the outer circumferential end that is closer to an outer circumference than is the inner circumferential end in the radial direction,
a sirocco vane portion that includes the outer circumferential end and forms a forward-curved blade at which an outlet angle is formed larger than 90 degrees,
a turbo vane portion that includes the inner circumferential end and forms a backward-curved blade,
a first region that is located closer to the main plate than is an intermediate position in an axial direction of the rotation axis, and
a second region that is located closer to the side plate than is the first region,
the plurality of blades having a blade outer diameter of the respective outer circumferential ends of the plurality of blades, the blade outer diameter being larger than an inner diameter of the bell mouth,
the plurality of blades each having a vane length in the first region that is greater than a vane length in the second region,
the plurality of blades each having a portion at which a proportion for which the turbo vane portion accounts is higher in the radial direction than a proportion for which the sirocco vane portion accounts in the first region and the second region,
in a case in which portions of the plurality of blades that are located closer to the outer circumference than is an inner circumferential side end portion that is an end portion of the bell mouth that is located closest to an inner circumference in the radial direction is defined as a blade outer circumferential portion,
the blade outer circumferential portion being formed such that the proportion for which the sirocco vane portion accounts is higher in the radial direction than or equal to the proportion for which the turbo vane portion accounts in the first region and the second region.

2. The centrifugal air-sending device of claim 1, wherein
the plurality of blades each have a third region that is in the second region and in which a proportion for which the turbo vane portion accounts is higher in the radial direction than a proportion for which the sirocco vane portion accounts,
the plurality of blades each have a fourth region that is in the second region and in which a proportion for which the turbo vane portion accounts is lower in the radial direction than a proportion for which the sirocco vane portion accounts, and
the plurality of blades are each formed such that, in the second region, a proportion for which the third region accounts in the axial direction is larger than a proportion for which the fourth region accounts in the axial direction.

3. The centrifugal air-sending device of claim 1, wherein the plurality of blades are each formed such that the turbo vane portion and the sirocco vane portion are separated from each other in the second region.

4. The centrifugal air-sending device of claim 1, wherein the plurality of blades are each formed such that the turbo vane portion and the sirocco vane portion are separated from each other in the first region and the second region.

5. The centrifugal air-sending device of claim 1, wherein the plurality of blades each have an inclination portion that is inclined away from the rotation axis from the main plate toward the side plate.

6. The centrifugal air-sending device of claim 5, wherein the inclination portion is inclined to the rotation axis at an angle of larger than 0 degrees and smaller than or equal to 60 degrees.

7. The centrifugal air-sending device of claim 1, wherein a ratio of a blade inner diameter of the respective inner circumferential ends of the plurality of blades to a blade outer diameter of the respective outer circumferential ends of the plurality of blades is lower than or equal to 0.7.

8. The centrifugal air-sending device of claim 1, wherein,
when an interval between two blades of the plurality of blades that are next to each other in the circumferential direction is defined as a vane interval,
the vane interval of the turbo vane portions expands from the inner circumference toward the outer circumference in the radial direction, and
the vane interval of the sirocco vane portions is wider than the vane interval of the turbo vane portions and expands from the inner circumference toward the outer circumference in the radial direction.

9. The centrifugal air-sending device of claim 1, wherein the turbo vane portion linearly extends from the inner circumferential end toward the outer circumference in the radial direction.

10. The centrifugal air-sending device of claim 1, wherein
the plurality of blades each have a radial vane portion that connects between the turbo vane portion and the sirocco vane portion, and
the radial vane portion has a vane angle that is formed at 90 degrees.

11. The centrifugal air-sending device of claim 1, wherein
the plurality of blades include
a plurality of first blades, and
a plurality of second blades,
in a first section of the plurality of blades that is obtained by cutting the plurality of blades at the first region with a first flat surface that is perpendicular to the rotation axis, the plurality of first blades each have a vane length that is greater than a vane length of each of the plurality of second blades, and
at least one second blade of the plurality of second blades is located between each two first blades of the plurality of first blades that are next to each other in the circumferential direction.

12. The centrifugal air-sending device of claim 11, wherein a ratio of an inner diameter of the respective inner circumferential ends of the plurality of second blades to an outer diameter of the respective outer circumferential ends of the plurality of second blades is lower than or equal to 0.7.

13. The centrifugal air-sending device of claim 1, wherein
a blade outer diameter of the respective outer circumferential ends of the plurality of blades is larger than the inner diameter of the bell mouth, and
the plurality of blades each have a level-difference portion formed at an end portion of the turbo vane portion that are located closest to the side plate.

14. The centrifugal air-sending device of claim 1, wherein the inner diameter of the bell mouth is larger than a blade inner diameter of the respective inner circumferential ends of the plurality of blades in the first region and smaller than a blade inner diameter of the respective inner circumferential ends of the plurality of blades in the second region.

15. The centrifugal air-sending device of claim 1, wherein a closest-approach distance between which the plurality of blades are closest to the circumferential wall is larger than twice a radial length of the sirocco vane portion.

16. The centrifugal air-sending device of claim 1, further comprising
a motor that is located outside the scroll casing and has a motor shaft that is connected to the main plate and serves as the rotation axis of the main plate, wherein
an outer diameter of the motor is larger than a blade inner diameter of the plurality of blades at the main plate and is smaller than a blade inner diameter of the plurality of blades at the side plate.

17. The centrifugal air-sending device of claim 1, further comprising
a motor that is located outside the scroll casing and has a motor shaft that is connected to the main plate and serves as the rotation axis of the main plate, wherein
an outer diameter of an end portion of the motor is larger than a blade inner diameter of the plurality of blades at the main plate and is smaller than a blade inner diameter of the plurality of blades at the side plate.

18. An air-conditioning apparatus comprising the centrifugal air-sending device of claim 1.
